(19) United States
(12) Patent Application Publication
(10) Pub. No.: US 2005/0202342 A1
(43) Pub. Date: Sep. 15, 2005

(54) Planographic printing plate precursor

(75) Inventor: Akira Nagashima, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/075,706

(22) Filed: Mar. 10, 2005

(30) Foreign Application Priority Data
Mar. 11, 2004 (JP) 2004-69478

(51) Int. Cl. G03C 1/52

(52) U.S. Cl. 430/270.1

(57) ABSTRACT

A planographic printing plate precursor comprises: a support; and a recording layer disposed on the support, the recording layer comprising a lower layer and an upper layer disposed on the lower layer, wherein the lower layer contains a resin having in a main chain structure a phenol skeleton and a urea bond, the upper layer contains a water-insoluble alkali-soluble resin and an infrared absorber, and the solubility of the upper layer in an aqueous alkali solution is increased by exposure. The planographic printing plate precursor can be produced directly through scanning exposure based on digital signals. It is superior in reproducibility of highly fine images and also superior in printing durability and chemical resistance of small-area image areas such as halftone dots and thin lines.

### CROSS-REFERENCE TO RELATED APPLICATION

This application claims priority under 35 USC 119 from Japanese Patent Application No. 2004-69478, the disclosure of which is incorporated by reference herein.

### BACKGROUND OF THE INVENTION

1. Field of the Invention

The present invention relates to a planographic printing plate precursor that can be used as an offset printing master. More particularly, it relates to a so-called positive planographic printing plate precursor for direct plate-making capable of forming a printing plate directly from digital signals from a computer or the like.

2. Description of the Related Art

The development of lasers for planographic printing in recent years has been remarkable. In particular, high-power, small-sized solid lasers and semiconductor lasers that emit near-infrared and infrared rays have become easily obtainable. In the field of planographic printing, these lasers are very useful as exposure light sources when forming printing plates directly from digital data of computers or the like.

Materials which can be used for positive type planographic printing plate precursors applicable for infrared lasers include, as essential components, a binder resin soluble in an aqueous alkaline solution (hereinafter referred to where appropriate as an “alkali-soluble resin”), and an infra red dye which absorbs light to generate heat. When an image is formed in a positive type planographic printing plate precursor, the infra red dye interacts with the binder resin in its unexposed portions (image portions) so as to function as a dissolution inhibitor which can substantially reduce the solubility of the binder resin to the developer. On the other hand, in its exposed portions (non-image portions), interaction of the infra red dye with the binder resin is weakened by the heat generated. Consequently, an exposed portion can turn into a state in which it can be dissolved in an alkaline developer, so that an image is formed thereon and a planographic printing plate is produced.

Since the image forming ability of the positive planographic printing plate precursor used with the infrared laser depends on heat generation caused by irradiation with the infrared laser on a surface of the recording layer, the amount of heat used for forming images, i.e., for solubilization of the recording layer, is lowered in the vicinity of the support due to heat diffusion to the support, thereby lowering the sensitivity of the recording layer. Therefore, a problem arises in that an effect of development inhibiting function loss of the recording layer is not sufficiently obtained in the non-image area, and consequently, the difference between the image area and the non-image area decreases. In particular, the reproducibility of highly fine images, such as halftone dots and thin lines, is insufficient.

In the case of such highly fine images, the image forming property must be improved because the images have only a small area. If a recording layer comprising a material that allows the non-image area to be readily developed is used for this purpose, the planographic printing plate is susceptible to damage by the action of an ink cleaner and a plate cleaner used when printing, or of a developer or the like. In other words, such a planographic printing plate is poor in chemical resistance and printing durability.

In order to solve the above problems, a planographic printing plate precursor has been disclosed that has a recording layer which comprises a lower layer containing an acrylic resin and being excellent in alkali solubility and an upper layer including a water-insoluble alkali-soluble resin and an infrared absorber, the solubility of the upper layer in an aqueous alkali solution being greatly increased by exposure (see, for example, Japanese Patent Application Laid Open (JP-A) No. 10-250255).

According to this planographic printing plate precursor, it is possible to improve sensitivity and chemical resistance. However, there remain some problems; for example, (1) the adhesion between the support and the recording layer is insufficient, (2) the edge of the lower layer is damaged by an alkali developer in the boundary between an image area and a non-image area to cause a phenomenon called “side edge” and, as a result, the ON/OFF of images becomes unclear and the sharpness of images is reduced, and (3) especially in small-area image areas, the recording layer readily peels off and the printing durability in halftone dots or thin lines is poor.

Further, a variety of improved techniques have been proposed in order to attain similar objectives, including a process for producing a printing plate using a planographic printing plate precursor formed by laminating a lower layer which contains an alkali-soluble resin and an infrared-sensitive and alkali-development-resistive upper layer on a hydrophilic support (see, for example, JP-A No. 11-194483). However, there is a problem with this method in that, due to a low chemical resistance of the alkali-soluble resin used, when a plate cleaner or the like contacts with the end of the lower layer, it penetrates the layer to impair the film strength thereof and thereby the recording layer becomes liable to delamination.

Thus, it has been difficult to successfully combine both printing durability, which depends on the film strength of the lower layer, and chemical resistance (if the film strength of the lower layer is increased for improvement in printing durability, the chemical resistance will be reduced).

### SUMMARY OF THE INVENTION

The present invention has been made in view of the aforementioned problems associated with the conventional art, and aims to provide a positive planographic printing plate precursor which can directly form a printing plate by scanning exposure based on digital signals, which is superior in reproducibility of highly fine images to the extent that sharp images can be formed and which is superior in both printing durability and chemical resistance of small-area image areas such as halftone dots and thin lines.

After intensive research, the inventors found that the above-mentioned aim can be achieved by forming a lower layer containing a phenol resin having a specified structure as a recording layer of a planographic printing plate precursor and, thus, the invention was completed.

The planographic printing plate precursor of the invention includes a support and a recording layer disposed on the support, the recording layer including a lower layer and an upper layer disposed on the lower layer wherein the lower layer contains in the main chain structure both a resin having a phenol skeleton and a urea bond and wherein the upper layer contains a water-insoluble alkali-soluble resin and an infrared absorber, the solubility of the upper layer in an aqueous alkali solution being increased by exposure.

The mechanisms of the actions of the above-mentioned constitutional factors in the invention are not yet clearly understood. The resin having in the main chain structure both a phenol skeleton and a urea bond (henceforth, sometimes referred to as a specified phenol resin) used in the lower layer of the planographic printing plate precursor of the invention is excellent in film strength even when used by itself to form film and, therefore, it contributes to improvement in printing durability. Since the specified phenol resin is also excellent in dissolving resistance in an organic solvent or the like in comparison to conventionally known acrylic alkali-soluble resins, it is not susceptible to damage by the action of a plate cleaner or the like.

In addition, due to the presence of a phenolic hydroxyl group in the resin, it has good affinity for the alkali-soluble resin contained in the upper layer and adhesion between the upper and lower layers is favorable. Because of this, high film strength and high chemical resistance are effectively exerted in image areas, i.e., areas where the upper layer of the recording layer exists as an alkali development resistant layer.

In addition, because of such excellent adhesion with the alkali development resistant layer (upper layer), excellent printing durability is exhibited even in small-area image areas.

On the other hand, a non-image area from which the upper layer has been removed dissolves and disperses rapidly in an alkali developer because of its inherent alkali solubility and the lower layer is thought to be superior in formability of fine images for this reason.

In short, according to the invention, it is possible to provide a positive planographic printing plate precursor which can be produced directly through scanning exposure based on digital signals, which is superior in reproducibility of highly fine images to the extent that sharp images can be formed and which is superior in both printing durability and chemical resistance of small-area image areas such as halftone dots and thin lines.

### DETAILED DESCRIPTION OF THE INVENTION

The present invention is explained in detail below.

The planographic printing plate precursor of the invention comprises a support and a recording layer disposed on the support, the recording layer including a lower layer and an upper layer disposed on the lower layer wherein the lower layer contains a resin having in the main chain structure both a phenol skeleton and a urea bond and wherein the upper layer contains a water-insoluble alkali-soluble resin and an infrared absorber, the solubility of the upper layer in an aqueous alkali solution being increased by exposure.

The components of the planographic printing plate precursor of the invention will be described one after another in detail below.

[Lower Layer Containing a Resin having in Main Chain Structure Phenol Skeleton and Urea Bond]

The lower layer in the invention is characterized by containing a resin having in the main chain both a phenol skeleton and a urea bond.

The specified phenol resin used herein is a resin having in the main chain both a phenol skeleton and a urea bond (—NHCONH—). The phenolic hydroxyl group in the main chain may be a derivative of ester, ether, or the like. The resin is preferably insoluble in water but soluble in aqueous alkali solution and is preferably a resin resulting from polycondensation of dimethylolurea and a monomer selected from the group consisting of phenols, bisphenols, hydroxynaphthalenes, and a low-molecular-weight condensed compound of p-cresol/formaldehyde.

In the specified phenol resin, a phenolic hydroxyl group may be replaced by a substituent selected from the group consisting of an ether group, an ester group, a urea group and a carbonate group.

Specific examples of such specified phenol resins include resins having structural units represented by formula (I) below.

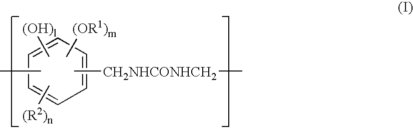

In formula (I), R¹ denotes an ether residue, an ester residue, an urethane residue or a carbonate residue. R² represents a monovalent organic residue having 1 to 20 carbon atoms. The organic residue may have a substituent.

R¹ and R² are preferably groups specifically shown below. When R² has a substituent, examples of the substituent that may be introduced include hydrocarbon groups having up to 12 carbon atoms, alkoxy groups, ester groups, an acetyl group, substituted amino groups, an ureido group and halogen atoms.

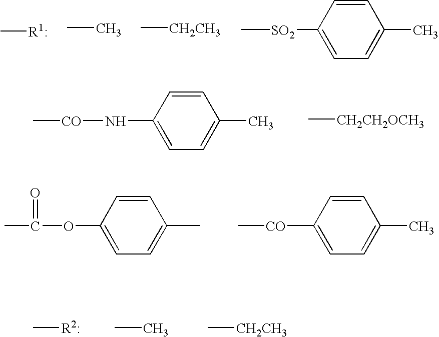

“l” denotes an integer of from 1 to 4. m and n each independently denote 0 or an integer of from 1 to 3. Here, “l”+m+n is from 1 to 4.

The specified phenol resin that can be preferably used in the invention can be obtained, for example, by subjecting a monomer having a phenol skeleton and N,N′-dimethylol urea (DMU) to condensation polymerization.

The specified phenol resin according to the invention may be a resin in which the phenolic hydroxyl group has been replaced by a substituent through a modification reaction. Specific examples of the substituent include an ether group (—OR⁰), an ester group (—OCOR⁰), a urethane group (—OCONHR⁰) and a carbonate group (—OCO₂R⁰). Such a modified specified phenol resin is preferably used from the viewpoint of improvement in solvent resistance. R⁰ represents a hydrocarbon group having 1 to 20 carbon atoms. The hydrocarbon group may have a substituent.

Examples of the modification reaction of the specified phenol resin include substitution reactions with an organic halide, an organosilane compound or an organic silylchloride, and an addition reaction with a reactive compound such as an isocyanate compound or an epoxy compound.

Specifically, examples of reactions of the specified phenol resin which are conducted in the presence of a basic compound include the following. Examples of such modified resins include ether derivatives resulting from a reaction with an organic halogen compound, silyl ether derivatives resulting from a reaction with an organic silyl chloride, silyl ether derivatives resulting from a reaction with an organic silane or siloxane, ester derivatives resulting from a reaction with an organic acid chloride such as an organic acid chloride, an organic sulfonic acid chloride or an organic phosphoric acid chloride, and carbonate derivatives resulting from a reaction with a chloroformic acid ester. Urethane derivatives resulting from an addition reaction with an isocyanate and ether derivatives resulting from an addition reaction with an epoxy compound are also preferred.

The specified phenol resin according to the invention is preferably a phenol resin having structural units represented by formula (I) shown above. From the viewpoints of solvent resistance and ease of handling, a resin containing in the molecule from 10 to 100% by mass, and more preferably from 50 to 100% by mass, of structural units represented by formula (I) is preferred.

Specific examples of copolymerized components other than formula (I) include structural units having (1) a phenolic hydroxyl group, (2) a sulfonamide group or (3) an active imide group. More specific preferable examples are bisphenol As and naphthalenes, which are phenols.

Regarding the molecular weight of the specified phenol resin, from the viewpoints of solvent resistance and solubility in coating solvent, the weight-average molecular weight is preferably 1,000 or more, and more preferably from 2,000 to 50,000 and the number-average molecular weight is preferably 500 or more, and more preferably from 1,000 to 20,000.

The specified phenol resin used in the invention is heretofore known and is disclosed as a photosensitive composition, for example, in JP-A No. 2003-315995. However, in order for the resin to be used as an outermost layer of a recording layer, there remained some problems with respect to inking property and the like, which needed to be solved. However, it was found that by using the resin in a lower layer of a multilayered recording layer, excellent effects are exhibited with respect to sharpness of images and halftone dot printing durability.

The specified phenol resin may be used singly or in combination of two or more types thereof in the lower layer.

The content of the specified phenol resin contained in the components of the lower layer of the invention is from 20 to 95% by weight, and preferably from 50 to 80% by weight, based on the total solid content.

The components of the lower layer of the invention may contain another resin in addition to the specified phenol resin unless the effect of the invention is thereby impaired. Since the lower layer itself must exhibit alkali solubility especially in non-image areas, a resin which does not impair this property must be chosen.

From this standpoint, one example of the resin which can be used together with the specified phenol resin is a water-insoluble alkali-soluble resin. Especially, preferable examples include polyamide resin, epoxy resin, polyacetal resin, acrylic resin, methacrylic resin, polystyrene resin and novolak-type phenol resin.

The mixing amount thereof is preferably up to 50% by mass relative to the specified phenol resin.

[Upper Layer Containing Water-Insoluble Alkali-Soluble Resin and Infrared Absorber, the Solubility of which Layer in Aqueous Alkali Solution is Increased by Exposure]

The upper layer of the invention is characterized by containing a water-insoluble alkali-soluble resin (hereinafter, referred sometimes to as an “alkali-soluble resin”) and an infrared absorber, and in that the solubility of the upper layer in an aqueous alkali solution is increased by exposure. The components of the upper layer of the invention will be described below.

(Water-Insoluble Alkali-Soluble Resin)

The alkali-soluble resin that may be used in the upper layer of the invention is not particularly limited insofar as it has such characteristics as being soluble in an alkali developer upon contact therewith, and preferable examples are a homopolymer containing an acidic group in a main chain and/or a side chain of the polymer, and a copolymer or a mixture thereof.

Examples of the alkali-soluble resin having an acidic group include a polymer compound containing in the molecule a functional group selected from (1) a phenolic hydroxyl group, (2) a sulfonamide group and (3) an active imide group. Specific examples thereof include the following, but the invention is not limited thereto.

(1) Examples of the macromolecular compounds comprising phenolic hydroxyl group may include novolak resin such as condensation polymers of phenol and formaldehyde, condensation polymers of m-cresol and formaldehyde, condensation polymers of p-cresol and formaldehyde, condensation polymers of m-/p-mixed cresol and formaldehyde, and condensation polymers of phenol/cresol (m-, p-, or m-/p-mixture) and formaldehyde; and condensation copolymers of pyrogallol and acetone.

As the macromolecular compound having a phenolic hydroxyl group, it is preferable to use macromolecular compounds having a phenolic hydroxyl group at their side chains besides the above compounds. Examples of the macromolecular compound having a phenolic hydroxyl group at its side chain include macromolecular compounds obtained by homopolymerizing a polymerizable monomer comprising a low-molecular compound having one or more phenolic hydroxyl groups and one or more polymerizable unsaturated bonds or copolymerizing this monomer with other polymerizable monomers.

Examples of the polymerizable monomer having a phenolic hydroxyl group include acrylamides, methacrylamides, acrylates and methacrylates each having a phenolic hydroxyl group or hydroxystyrenes. Specific examples of the polymerizable monomer which may be preferably used include N-(2-hydroxyphenyl)acrylamide, N-(3-hydroxyphenyl)acrylamide, N-(4-hydroxyphenyl)acrylamide, N-(2-hydroxyphenyl)methacrylamide, N-(3-hydroxyphenyl)methacrylamide, N-(4-hydroxyphenyl)methacrylamide, o-hydroxyphenylacrylate, m-hydroxyphenylacrylate, p-hydroxyphenylacrylate, o-hydroxyphenylmethacrylate, m-hydroxyphenylmethacrylate, p-hydroxyphenylmethacrylate, o-hydroxystyrene, m-hydroxystyrene, p-hydroxystyrene, 2-(2-hydroxyphenyl)ethylacrylate, 2-(3-hydroxyphenyl)ethylacrylate, 2-(4-hydroxyphenyl)ethylacrylate, 2-(2-hydroxyphenyl)ethylmethacrylate, 2-(3-hydroxyphenyl)ethylmethacrylate and 2-(4-hydroxyphenyl)ethylmethacrylate. Two or more types of these resins having phenolic hydroxyl group may be used in combination. Moreover, condensation polymers of phenols having an alkyl group having 3 to 8 carbon atoms as a substituent and formaldehyde, such as a t-butylphenol formaldehyde resin and octylphenol formaldehyde resin as described in the specification of U.S. Pat. No. 4,123,279 may be used together.

(2) Examples of the alkali-soluble macromolecular compound having a sulfonamide group include macromolecular compounds obtained by homopolymerizing polymerizable monomers having a sulfonamide group or by copolymerizing the monomer with other polymerizable monomers. Examples of the polymerizable monomer having a sulfonamide group include polymerizable monomers comprising a low-molecular compound having, in one molecule thereof, one or more sulfonamide groups —NH—SO₂— in which at least one hydrogen atom is added to a nitrogen atom and one or more polymerizable unsaturated bonds. Among these compounds, low-molecular compounds having an acryloyl group, allyl group or vinyloxy group and a substituted or monosubstituted aminosulfonyl group or substituted sulfonylimino group are preferable.

(3) The alkali-soluble macromolecular compound having an active imide group is preferably those having an active imide group in its molecule. Examples of the macromolecular compound include macromolecular compounds obtained by homopolymerizing a polymerizable monomer comprising a low-molecular compound having one or more active imide groups and one or more polymerizable unsaturated bonds or copolymerizing this monomer with other polymerizable monomers.

Specifically, as such a compound, N-(p-toluenesulfonyl)methacrylamide and N-(p-toluenesulfonyl)acrylamide, for example, may be suitably employed.

The alkali-soluble resin used in the invention is preferably a polymer compound obtained by polymerizing two or more of a polymerizable monomer having a phenolic hydroxyl group, a polymerizable monomer having a sulfonamide group and a polymerizable monomer having an active amide group. There is no particular limitation to the copolymerization ratio of the polymerizable monomers and the combination of the polymerizable monomers. When a polymerizable monomer having a sulfonamide group and/or a polymerizable monomer having an active imide group is copolymerized with a polymerizable monomer having a phenolic hydroxyl group, in particular, the ratio by weight of these components to be compounded is preferably in a range from 50:50 to 5:95 and particularly preferably in a range from 40:60 to 10:90.

It is also preferable that the alkali-soluble resin used in the invention be a polymer compound obtained by copolymerizing another polymerizable monomer in addition to one kind or two or more kinds of polymerizable monomer selected from a polymerizable monomer having a phenolic hydroxyl group, a polymerizable monomer having a sulfonamide group and a polymerizable monomer having an active amide group. The copolymerization ratio used in this case is preferably determined so that the monomer imparting alkali-solubility is contained in an amount of 10 mole % or more, and more preferably 20 mole % or more. If the amount of the copolymerization component derived from the monomer imparting alkali-solubility is less than 10 mole %, alkali-solubility is liable to be insufficient and the development latitude tends to decrease.

Examples of the other polymerizable monomers that may be used include the following compounds (m1) to (m12), but the invention is not limited thereto.

(m1) Acrylic acid esters and methacrylic acid esters having aliphatic hydroxyl groups such as 2-hydroxyethyl acrylate or 2-hydroxyethyl methacrylate.

(m2) Alkyl acrylate such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.

(m3) Alkyl methacrylate such as methyl methacrylate, ethyl methacrylate, propyl methacrylate, butyl methacrylate, amyl methacrylate, hexyl methacrylate, cyclohexyl methacrylate, benzyl methacrylate, 2-chloroethyl methacrylate, and glycidyl methacrylate.

(m4) Acrylamide or methacrylamide such as acrylamide, methacrylamide, N-methylol acrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacxrylamide.

(m5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.

(m6) Vinyl esters such as vinyl acetate, vinyl chloroacetate, vinyl butylate, and vinyl benzoate.

(m7) Styrenes such as styrene, α-methylstyrene, methylstyrene, and chloromethylstyrene.

(m8) Vinyl ketones such as methyl vinyl ketone, ethyl vinyl ketone, propyl vinyl ketone, and phenyl vinyl ketone.

(m9) Olefins such as ethylene, propylene, isobutylene, butadiene, and isoprene.

(m10) N-vinylpyrrolidone, acrylonitrile, and methacrylonitrile.

(m11) Unsaturated imides such as maleimide, N-acryloylacrylamide, N-acetylmethacrylamide, N-propionylmethacrylamide, and N-(p-chlorobenzoyl)methacrylamide.

(m12) Unsaturated carboxylic acid such as acrylic acid, methacrylic acid, maleic anhydride, and itaconic acid.

In the case where the alkali-soluble resin used in the invention is a homopolymer or a copolymer of a polymerizable monomer having a phenolic hydroxyl group, a polymerizable monomer having a sulfonamide group and a polymerizable monomer having an active imide group, it preferably has a weight-average molecular weight of 2,000 or more and a number-average molecular weight of 500 or more. More preferably, it has a weight-average molecular weight of from 5,000 to 300,000, a number-average molecular weight of from 800 to 250,000 and a dispersion degree (weight-average molecular weight/number-average molecular weight) of from 1.1 to 10.

In the case where the alkali-soluble resin used in the invention is a phenol-formaldehyde resin or a cresol-aldehyde resin, it particularly preferably has a weight-average molecular weight of from 500 to 20,000 and a number-average molecular weight of from 200 to 10,000.

The alkali-soluble resin used in the invention is preferably a resin having a phenolic hydroxyl group from the standpoint of being capable of forming strong hydrogen bonding in an unexposed area while readily releasing some of the hydrogen bonds in an exposed area. In particular, a novolak resin is preferred as the resin having a phenolic hydroxyl group.

In the invention, two or more kinds of alkali-soluble resins differing in dissolving rate in an aqueous alkali solution may be used as a mixture, and, in such a case, the mixing ratio thereof may be freely determined. As an alkali-soluble resin that is preferably mixed with the resin having a phenolic hydroxyl group, an acrylic resin is preferable since it has a low compatibility with the resin having a phenolic hydroxyl group, and an acrylic resin having a sulfonamide group is more preferable.

The content of the alkali-soluble resin in the upper layer of the invention is preferably from 50 to 98% by mass, based on the total solid content of the upper layer, from the viewpoint of sensitivity and durability of the recording layer. In the case where two or more kinds of alkali-soluble resins are used in combination, the content amount indicates the total amount of the resins.

[Infrared Absorber]

In the planographic printing plate precursor of the invention, an infrared absorber must be added to the upper layer of the recording layer. The addition of the infrared absorber renders the recording layer infrared laser-sensitive. As the infrared absorber, various dyes known as infrared absorbing dyes may be used without any particular limitations as long as they have an absorption maximum at wavelengths of from 750 nm to 1,400 nm and they absorb light of such wavelengths to generate heat.

The infrared ray-absorbing dyes favorably used in the invention include commercially available dyes and publicly known dyes described in literature (e.g., “Dye manual”, the Society of Synthetic Organic Chemistry, Japan Ed., 1970). Specific examples thereof include azo dyes, metal complex salt azo dyes, pyrazolone azo dyes, anthraquinone dyes, phthalocyanine dyes, carbonium dyes, quinonimine dyes, methine dyes, cyanine dyes and the like. Among these dyes, dyes absorbing an infrared light or dyes absorbing a near-infrared light are particularly preferable in the invention, as they are suitable for use together with a laser having a wavelength in the infrared light or near-infrared region.

Typical examples of these infrared ray-absorbing dyes and near-infrared ray-absorbing dyes include cyanine dyes described in JP-A Nos. 58-125246, 59-84356, 59-202829 and 60-78787; methine dyes described in JP-A Nos. 58-173696, 58-181690, and 58-194595, and others; naphthoquinone dyes described in JP-A Nos. 58-112793, 58-224793, 59-48187, 59-73996, 60-52940, and 60-63744, and others; squarylium dyes described in JP-A No. 58-112792 and others; cyanine dye described in U.K. Patent No. 434,875; and the like.

Preferable examples of the dyes include infrared-absorbing sensitizers described in U.S. Pat. No. 5,156,938; arylbenzo(thio)pyrylium salts described in U.S. Pat. No. 3,881,924; trimethine thiapyrylium salts described in JP-A No. 57-142645; pyrylium compounds described in JP-A Nos. 58-181051, 58-220143, 59-41363, 59-84248, 59-84249, 59-146063, and 59-146061; cyanine dyes described in JP-A No. 59-216146; pentamethine thiopyrylium salts and the like described in U.S. Pat. No. 4,283,475; pyrylium compounds and the like described in Jan. Examined Patent Publication Nos. 5-13514 and 5-19702; commercial products such as Epolight III-178, Epolight III-130, and Epolight III-125 manufactured by Epolin, Inc.; and the like.

Other preferable examples thereof include infrared-absorbing dyes represented by Formulae (I) and (II) described in U.S. Pat. No. 4,756,993.

Particularly preferable among these dyes are cyanine dyes, squalelium dyes, pyrylium salts, nickel/thiolate complexes and indolenine cyanine dyes. Cyanine dyes and indolenine cyanine dyes are even more preferable. One example of especially preferable dyes is a cyanine dye represented by formula (a) shown below.

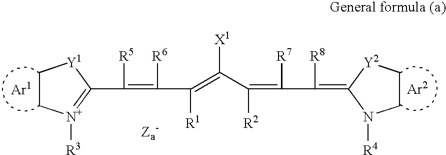

In general formula (a), X¹ represents a hydrogen atom, a halogen atom, —NPh₂, X²-L¹ (wherein X² represents an oxygen atom or a sulfur atom, L¹ represents a hydrocarbon group having 1 to 12 carbon atoms, an aromatic cyclic group having a heteroatom, or a hydrocarbon group containing a heteroatom and having 1 to 12 carbon atoms, and the heteroatom referred to herein is N, S, O, a halogen atom, or Se), or a group represented by the following: 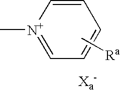
wherein Xa⁻ has the same definition as Za⁻, which will be described at a later time, and R^{a} represents a substituent selected from a hydrogen atom, an alkyl group, an aryl group, a substituted or unsubstituted amino group, or a halogen atom;
R¹ and R² each independently represents a hydrocarbon group having 1 to 12 carbon atoms, and from the viewpoint of the storage stability of the photosensitive composition of the invention when it is used in a coating solution for forming a recording layer of a planographic printing plate precursor, it is preferable that R¹ and R² each independently represents a hydrocarbon group having 2 or more carbon atoms, and more preferably R¹ and R² are bonded to each other to form a 5-membered or 6-membered ring.

Ar¹ and Ar², which may be the same or different, each represent an aromatic hydrocarbon group which may have a substituent. Preferable examples of the aromatic hydrocarbon group include benzene and naphthalene rings. Preferable examples of the substituent include hydrocarbon groups having 12 or less carbon atoms, halogen atoms, and alkoxy groups having 12 or less carbon atoms.

Y¹ and Y², which may be the same or different, each represents a sulfur atom, or a dialkylmethylene group having 12 or less carbon atoms.

R³ and R⁴, which may be the same or different, each represents a hydrocarbon group which has 20 or less carbon atoms and may have a substituent. Preferable examples of the substituent include alkoxy groups having 12 or less carbon atoms, a carboxyl group, and a sulfo group.

R⁵, R⁶, R⁷ and R⁸, which may be the same or different, each represents a hydrogen atom, or a hydrocarbon group having 12 or less carbon atoms, and since the raw materials thereof can easily be obtained, each preferably represents a hydrogen atom.

Further, Za⁻ represents a counter anion. It should be noted that when the cyanine dye represented by formula (a) has an anionic substituent in its structure and does not require neutralization of the charge, Za⁻ is not necessary. In view of storability of the coating solution of the recording layer, Za⁻ is preferably a halogen ion, a perchlorate ion, a tetrafluoroborate ion, a hexafluorophosphate ion or a sulfonate ion, and particularly preferably a perchlorate ion, a hexafluorophosphate ion or an aryl sulfonate ion.

Examples of the cyanine dyes represented by the formula (a), which can be preferably used in the invention, include those disclosed in paragraphs [0017] to [0019] of JP-A No. 2001-133969.

Although the infrared absorber is contained as an essential component in the upper layer of the recording layer from the viewpoint of sensitivity, it may also be contained in the lower layer. By adding an infrared absorber to the lower layer, it is possible to improve the sensitivity due to local generation of heat in an exposed area. Moreover, by adding a substance having dissolution inhibitability, such as a cyanine dye, as an infrared absorber, it is possible to make the lower layer serve as a heat-sensitive recording layer. When an infrared absorber is added to both the upper and lower layers, the same compound may be used for both layers or alternatively different compounds may be used.

Further, such infrared absorbers may by added to the recording layer or alternatively may be added to another layer formed separately from the recording layer. When adding the infrared absorber to a layer other than the recording layer, it is desirable to add it to a layer adjacent to the recording layer.

Infrared absorbers such as the cyanine dyes provided above as preferable dyes can serve as agents for inhibiting dissolution of the aforementioned alkali-soluble resin through formation of an interaction with the alkali-soluble resin. When using a compound as an infrared absorber other than such compounds having dissolution inhibitability, it is desirable to add a dissolution inhibitor mentioned below to the upper layer.

Regarding the amount of the infrared absorber added, it may be added to the upper layer in an amount of from 0.01 to 50% by mass, preferably from 0.1 to 30% by mass, and particularly preferably from 1.0 to 30% by mass, based on the total solid content of the upper layer. If the amount is less than 0.01% by mass, the sensitivity is lowered. If it exceeds 50% by mass, the uniformity or the upper recording layer is lost and the durability of the upper recording layer is lowered.

The infrared absorber may optionally be added also to the lower layer. When adding it to the lower layer, it is desirable to add it in an amount of from 0 to 20% by mass, preferably from 0 to 10% by mass, and particularly preferably from 0 to 5% by mass, based on the total solid content of the lower layer.

In the case where the infrared absorber is added to the lower layer, if an infrared absorber having dissolution inhibitability is used, the solubility of the lower layer is lowered. On the other hand, since the infrared absorber generates heat on exposure to infrared laser, the solubility of the lower layer is expected to increase due to the heat. Therefore, the kind of compound to be added and the amount thereof should be determined with consideration of the balance between these characteristics.

[Development Inhibitor]

It is desirable that a development inhibitor be contained in the upper layer of the invention for enhancing inhibition (solubilization inhibiting function).

The development inhibitor used in the invention is not particularly limited insofar as it causes an interaction with the alkali-soluble resin such that the solubility of the alkali-soluble resin in a developer is substantially lowered in an unexposed area, and in an exposed area, the alkali-soluble resin exhibits a reduced interaction and is soluble in the developer. In particular, a quaternary ammonium salt and a polyethylene glycol-type compound are preferably used. When a compound having a function as a development inhibitor is used as the infrared absorber, there is no need to add a development inhibitor such as those described below.

The quaternary ammonium salt is not limited to specific kinds, and examples thereof include tetraalkylammonium, trialkylarylammonium, dialkyldiarylammonium, alkyltriarylammonium, tetaraarylammonium, cyclic ammonium, and bicyclic ammonium salts.

Specific examples thereof include tetrabutylammonium bromide, tetrapentylammonium bromide, tetrahexylammonium bromide, tetraoctylammonium bromide, tetralaurylammonium bromide, tetraphenylammonium bromide, tetranaphthylammonium bromide, tetrabutylammonium chloride, tetrabutylammonium iodide, tetrastearylammonium bromide, lauryltrimethylammonium bromide, stearyltrimethylammonium bromide, behenyltrimethylammonium bromide, lauryltriethylammonium bromide, phenyltrimethylammonium bromide, 3-trifluoromethylphenyltrimethylammonium bromide, benzyltrimethylammonium bromide, dibenzyldimethylammonium bromide, distearyldimethylammonium bromide, tristearylmethylammonium bromide, benzyltriethylammonium bromide, hydroxyphenyltrimethylammonium bromide and N-methylpyridinium bromide. In particular, quaternary ammonium salts disclosed in Japanese Patent Application Nos. 2001-226297, 2001-370059 and 2001-398047 are preferred.

The amount of the (solid) quaternary ammonium salt to be added is preferably from 0.1 to 50% by mass, more preferably from 1 to 30% by mass of all solid contents of the upper layer. When the amount of the quaternary ammonium is 0.1% by mass or less, the dissolution-suppressing effect of the salt is reduced, which is not preferable. When the amount of the quaternary ammonium is 50% by more, the film-forming properties of the alkali-soluble resin may be adversely affected.

The polyethylene glycol type compound is not limited to specific kinds, and may be a compound having a structure represented by the following general formula (I):
R¹—{—O—(R³—O—)ₘ—R²}ₙ (I)
wherein R¹ represents a polyhydric alcohol residue or polyhydric phenol residue; R² represents a hydrogen atom, or an alkyl, alkenyl, alkynyl, alkyloyl, aryl or aryloyl group which may each have a substituent and each have 1 to 25 carbon atoms; R³ represents an alkylene group which may have a substituent; m and n are an integer of 10 or more and an integer of 1 or more and 4 or less, respectively, on average.

Examples of the polyethylene glycol type compound represented by the general formula (I) include polyethylene glycols, polypropylene glycols, polyethylene glycol alkyl ethers, polypropylene glycol alkyl ethers, polyethylene glycol aryl ethers, polypropylene glycol aryl ethers, polyethylene glycol alkylaryl ethers, polypropylene glycol alkylaryl ethers, polyethylene glycol glycerin esters, polypropylene glycol glycerin esters, polyethylene sorbitol esters, polypropylene glycol sorbitol esters, polyethylene glycol aliphatic acid esters, polypropylene glycol aliphatic acid esters, polyethylene glycolized ethylenediamines, polypropylene glycolized ethylenediamines, polyethylene glycolized diethylenetriamine, and polypropylene glycolized diethylenetriamines.

Specific examples thereof include polyethylene glycol 1000, polyethylene glycol 2000, polyethylene glycol 4000, polyethylene glycol 10000, polyethylene glycol 20000, polyethylene glycol 5000, polyethylene glycol 100000, polyethylene glycol 200000, polyethylene glycol 500000, polypropylene glycol 1500, polypropylene glycol 3000, polypropylene glycol 4000, polyethylene glycol methyl ether, polyethylene glycol ethyl ether, polyethylene glycol phenyl ether, polyethylene glycol dimethyl ether, polyethylene glycol diethyl ether, polyethylene glycol diphenyl ether, polyethylene glycol lauryl ether, polyethylene glycol dilauryl ether, polyethylene glycol nonyl ether, polyethylene glycol cetyl ether, polyethylene glycol stearyl ether, polyethylene glycol distearyl ether, polyethylene glycol behenyl ether, polyethylene glycol dibehenyl ether, polypropylene glycol methyl ether, polypropylene glycol ethyl ether, polypropylene glycol phenyl ether, polypropylene glycol dimethyl ether, polypropylene glycol diethyl ether, polypropylene glycol diphenyl ether, polypropylene glycol lauryl ether, polypropylene glycol dilauryl ether, polypropylene glycol nonyl ether, polyethylene glycol acetyl ester, polyethylene glycol diacetyl ester, polyethylene glycol benzoic acid ester, polyethylene glycol lauryl ester, polyethylene glycol dilauryl ester, polyethylene glycol nonylic acid, polyethylene glycol cetylic acid ester, polyethylene glycol stearoyl ester, polyethylene glycol distearoyl ester, polyethylene glycol behenic acid ester, polyethylene glycol dibehenic acid ester, polypropylene glycol acetyl ester, polypropylene glycol diacetyl ester, polypropylene glycol benzoic acid ester, polypropylene glycol dibenzoic acid ester, polypropylene glycol lauric acid ester, polypropylene glycol dilauric acid ester, polypropylene glycol nonylic acid ester, polyethylene glycol glycerin ether, polypropylene glycol glycerin ether, polyethylene glycol sorbitol ether, polypropylene glycol sorbitol ether, polyethylene glycolized ethylenediamine, polypropylene glycolized ethylendiamine, polyethylene glycolized diethylenetriamine, polypropylene glycolized diethylenetriamine, and polyethylene glycolized pentamethylenehexamine.

The amount of the polyethylene glycol compound added is preferably from 0.1 to 50% by mass, and more preferably from 1 to 30% by mass, based on the total solid content of the upper layer, from the viewpoint of development inhibition effect and image formability.

In the case that such manners for making the inhibition (i.e., dissolution inhibiting power) high are adopted, the sensitivity of the recording layer lowers. In this case, it is effective, in order to prevent the sensitivity from becoming low, to add a lactone compound to the composition. It appears that when developer penetrates into exposed portions (i.e., areas where the inhibition has been cancelled) of the recording layer, this lactone compound reacts with the developer to generate a new carboxylic acid compound, whereby the dissolution of the exposed areas of the recording layer is promoted to improve the sensitivity.

Such a lactone compound is not limited to specific kinds. Examples thereof include compounds by the following general formulae (L-I) and (L-II):

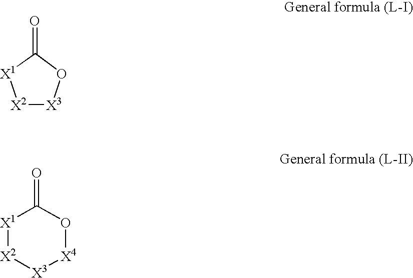

In the general formulae (L-I) and (L-II), X¹, X², X³ and X⁴ may be the same or different, and each represent a bivalent nonmetallic atom or nonmetallic atomic group which constitutes a part of the ring. These may each independently have a substituent. It is preferable that at least one of X¹, X² and X³ in the general formula (L-I), and at least one of X¹, X², X³ and X⁴ in the general formula (L-II) each have an electron withdrawing substituent or a substituent substituted with an electron withdrawing group.

The nonmetallic atom or nonmetallic atomic group is preferably an atom or atomic group selected from methylene, sulfinyl, carbonyl, thiocarbonyl, and sulfonyl groups, and sulfur, oxygen and selenium atoms, and is more preferably an atomic group selected from methylene, carbonyl and sulfonyl groups.

The electron withdrawing substituent (or group) referred to in the invention means a group having a positive Hammett substituent constant σp. About the Hammett substituent constant, the following can be referred to: Journal of Medicinal Chemistry, 1973, Vol. 16, No. 11, 1207-1216, and so on. Examples of the electron withdrawing group having a positive Hammett substituent constant σp include halogen atoms (such as a fluorine atom (σp value: 0.06), a chlorine atom (σp value: 0.23), a bromine atom (σp value: 0.23) and a iodine atom (σp value: 0.18)); trihaloalkyl groups (such as tribromomethyl (σp value: 0.29), trichloromethyl (σp value: 0.33), and trifluoromethyl (σp value: 0.54)); a cyano group (σp value: 0.66); a nitro group (σp value: 0.78); aliphatic, aryl or heterocyclic sulfonyl groups (such as methanesulfonyl (σp value: 0.72)); aliphatic, aryl or heterocyclic acyl groups (such as acetyl (σp value: 0.50) and benzoyl (σp value: 0.43)); alkynyl groups (such as C≡CH (σp value: 0.23)); aliphatic, aryl or heterocyclic oxycarbonyl groups (such as methoxycarbonyl (σp value: 0.45) and phenoxycarbonyl (σp value: 0.44)); and a carbamoyl group (σp value: 0.36); a sulfamoyl group (σp value: 0.57); a sulfoxide group; heterocyclic groups; an oxo group; and a phosphoryl groups.

Preferable examples of the electron withdrawing group include an amide group, an azo group, a nitro group, fluoroalkyl groups having 1 to 5 carbon atoms, a nitrile group, alkoxycarbonyl groups having 1 to 5 carbon atoms, acyl groups having 1 to 5 carbon atoms, alkylsulfonyl groups having 1 to 9 carbon atoms, arylsulfonyl groups having 6 to 9 carbon atoms, alkylsulfinyl groups having 1 to 9 carbon atoms, arylsulfinyl groups having 6 to 9 carbon atoms, arylcarbonyl groups having 6 to 9 carbon atoms, thiocarbonyl groups, fluorine-containing alkyl groups having 1 to 9 carbon atoms, fluorine-containing aryl groups having 6 to 9 carbon atoms, fluorine-containing allyl groups having 3 to 9 carbon atoms, an oxo group, and halogen atoms. More preferable examples of the electron withdrawing group include a nitro group, fluoroalkyl groups having 1 to 5 carbon atoms, a nitrile group, alkoxycarbonyl groups having 1 to 5 carbon atoms, acyl groups having 1 to 5 carbon atoms, arylsulfonyl groups having 6 to 9 carbon atoms, arylcarbonyl groups having 6 to 9 carbon atoms, an oxo group, and halogen atoms.

Specific examples of the compounds represented by the general formulae (L-I) and (L-II) are illustrated below. In the invention, however, the compounds are not limited to these compounds.

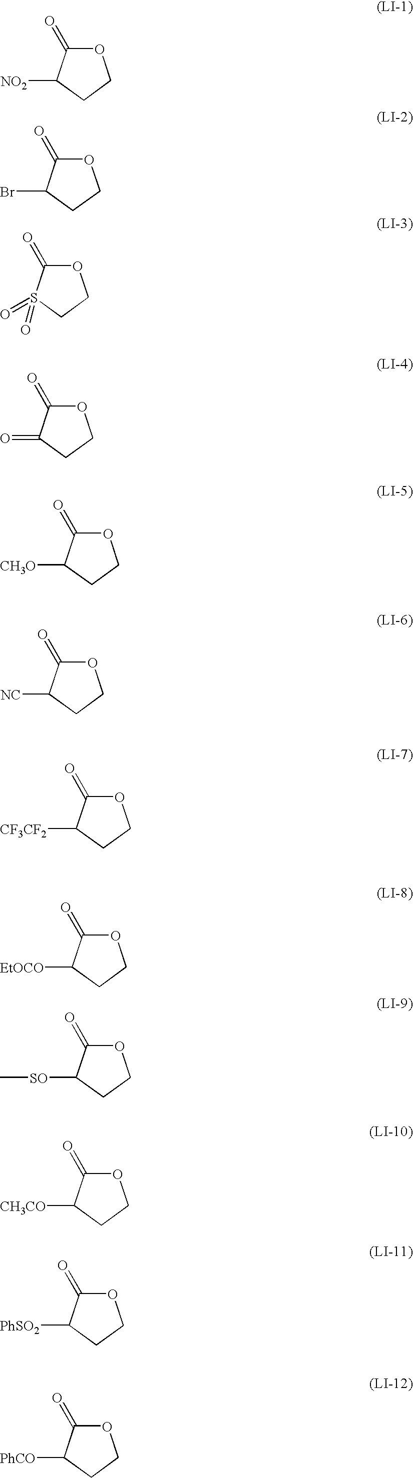

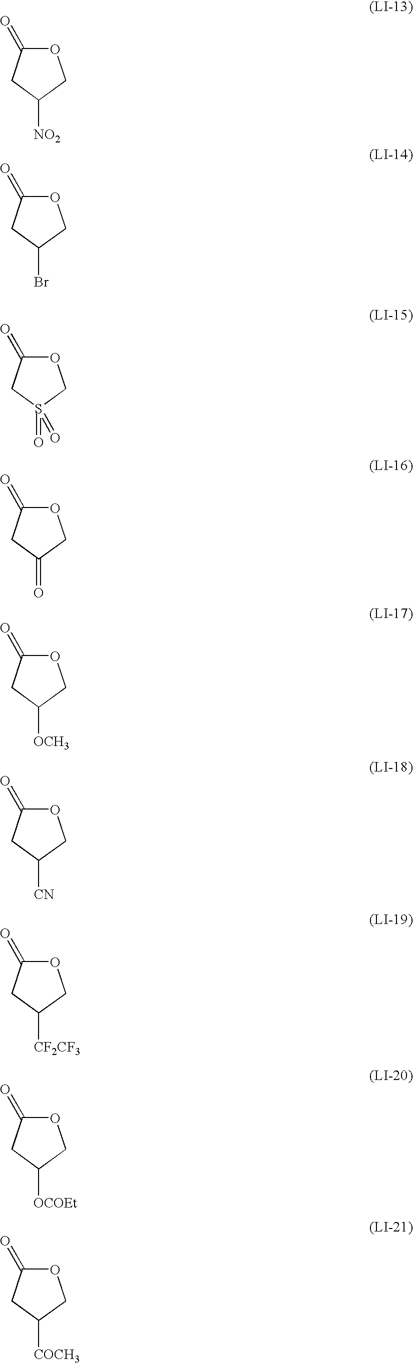

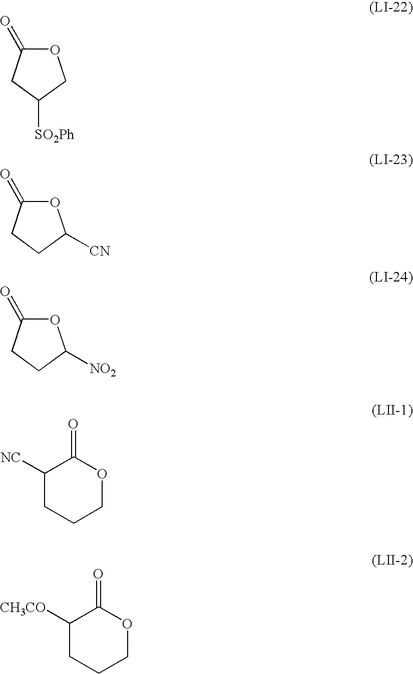

The (solid) amounts to be added, of the compounds represented by the general formulae (L-I) and (L-II), is preferably from 0.1 to 50% by mass, more preferably from 1 to 30% by mass of all solid contents of the upper layer, from the viewpoints of the better effects thereof.

The lactone compounds in the invention may be used alone or in combination of two or more thereof. In the case of using two or more types of the compounds represented by the general formula (L-I) or two or more types of the compounds represented by the general formula (L-II), the ratio between the added amounts of the these compounds may be arbitrary set if the total added amount of the compounds is within the above-mentioned range.

Further, it is desirable to use in combination a substance that is thermally decomposable and that substantially lowers the solubility of the alkali-soluble resin in an undecomposed state, such as onium salts, o-quinonediazide compounds, aromatic sulfone compounds and aromatic sulfonate compounds, in order to improve the inhibition of image areas to a developer.

Examples of the onium salts used in the invention include diazonium salts, ammonium salts, phosphonium salts, iodonium salts, sulfonium salts, selenonium salts, and arseninum salts.

Particularly preferable examples thereof include diazonium salts described in S. I. Schlesinger, Photogr. Sci. Eng., 18, 387 (1974), T. S. Bal et al., Polymer, 21, 423 (1980), and JP-A No. 5-158230; ammonium salts described in U.S. Pat. Nos. 4,069,055 and 4,069,056, and JP-A No. 3-140140; phosphonium salts described in D. C. Necker et al, Macromolecules, 17, 2468 (1984), C. S. Wen et al., The, Proc. Conf. Rad. Curing ASIA p. 478, Tokyo, Oct. (1988), and U.S. Pat. Nos. 4,069,055 and 4,069,056; iodonium salts described in J. V. Crivello et al., Macromolecules, 10(6), 1307 (1977), Chem. & Eng. News, Nov. 28, p. 31 (1988), EP No. 104,143, U.S. Pat. No. 5,041,358, EP No. 4,491,628, and JP-A Nos. 2-150848 and 2-296514; sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984), J. V. Crivello et al., Polymer Bull., 14, 279 (1985), J. V. Crivello et al., Macromolecules, 14 (5), 1141 (1981), J. V. Crivello et al., J. Polymer Sci., Polymer Chem. Ed., 17, 2877 (1979), EP Nos. 370,693, 233, 567, 297,443 and 297,442, U.S. Pat. Nos. 4,933,377, 3,902,114, 4,491,628, 4,760,013, 4,734,444 and 2,833,827, and DE Patents Nos. 2,904,626, 3,604,580, 3,604,581; selenonium salts described in J. V. Crivello et al., Macromolecules, 10 (6), 1307 (1977), J. V. Crivello et al., J. Polymer Sci., Polymer Chem. Ed., 17, 1047 (1979); and arsenonium slats described in C. S. Wen et al., The, Proc. Conf. Rad. Curing ASIA p. 478 Tokyo, Oct. (1988).

Of these onium salts, diazonium salts are particularly preferable. Particularly preferable examples of the diazonium salts include salts described in JP-A No. 5-158230.

Examples of the counter ion for the onium salt include tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoyl-benzenesulfonic acid, and paratoluenesulfonic acid ions. Among these, hexafluorophosphoric acid and alkylaromatic sulfonic acids, such as triisopropylnaphthalenesulfonic acid and 2,5-dimethylbenzenesulfonic acid, are particularly preferred.

The quinonediazide compounds are preferably o-quinonediazide compounds. The o-quinonediazide compounds are compounds which each have at least one o-quinonediazide group and each have alkali-solubility increased by being thermally decomposed, and which may have various structures. In other words, the o-quinonediazide compounds assist the dissolution of the upper layer by both of the effect that the compounds are thermally decomposed so that their inhibition for the developing inhibitor is lost and the effect that the o-quinonediazide compounds themselves change to alkali-soluble substances.

Such an o-quinonediazide compound may be, for example, a compound described in J Cohser “Light-Sensitive Systems” (John & Wiley & Sons. Inc.), pp. 339-352. Particularly preferable is a sulfonic acid ester or sulfonamide of o-quinonediazide, which is obtained by reacting the o-quinonediazide with an aromatic polyhydroxy compound or aromatic amino compound. Preferable are also an ester made from benzoquinone-(1,2)-diazidesulfonic acid chloride or naphthoquinone-(1,2)-diazide-5-sulfonic acid chloride and pyrogallol-acetone resin, described in Japanese Patent Application Laid-Open (JP-B) No. 43-28403; an ester made from benzoquinone-(1,2)-diazidesulfonic acid chloride or naphthoquinone-(1,2)-diazide-5-sulfonic acid chloride and phenol-formaldehyde resin, described in U.S. Pat. Nos. 3,046,120 and 3,188,210.

Furthermore, preferable are an ester made from naphthoquinone-(1,2)-diazide-4-sulfonic acid chloride and phenol formaldehyde resin or cresol-formaldehyde resin, and an ester made from naphthoquinone-(1,2)-diazide-4-sulfonic acid chloride and pyrogallol-acetone resin. Other useful o-quinonediazide compounds are reported and disclosed in many examined or unexamined patent documents, for example, JP-A Nos. 47-5303, 48-63802, 48-63803, 48-96575, 49-38701 and 48-13354, JP-B Nos. 41-11222, 45-9610 and 49-17481, U.S. Pat. Nos. 2,797,213, 3,454,400, 3,544,323, 3,573,917, 3,674,495 and 3,785,825, GB Patents Nos. 1,227,602, 1,251,345, 1,267,005, 1,329,888 and 1,330,932, and DE Patent No. 854,890.

The added amount of the o-quinonediazide compound is preferably from 1 to 50% by mass, more preferably from 5 to 30% by mass, even more preferably from 10 to 30% by mass of all solid contents of the upper layer. The above-mentioned o-quinonediazide compounds may be used alone or in a mixture form.

An alkali-soluble resin that has been at least partially esterified, as disclosed in JP-A No. 11-288089, may also be included.

In order to strengthen the inhibition on the surface of the recording layer and to strengthen scratch resistance on the surface, it is desirable to use in combination a polymer containing, as a polymerization component, a (meth)acrylate monomer having two or three perfluoroalkyl groups having from 3 to 20 carbon atoms in the molecule, as disclosed in JP-A No. 2000-187318.

The amount of the polymer added is preferably from 0.1 to 10% by mass, and more preferably from 0.5 to 5% by mass, based on the total solid content of the upper layer.

[Other Additives]

Upon forming the lower layer and the upper layer of the recording layer, various kinds of additives may further be added, depending on necessity, in addition to the aforementioned essential components, as long as the effect of the invention is not thereby impaired. Examples of the additives are shown below, and these may be added only to the lower layer, only to the upper layer, or to both layers.

(Development Accelerator)

For improvement in sensitivity, an acid anhydride, a phenol compound and an organic acid may be added to the upper layer and/or the lower layer of the recording layer of the invention.

As the acid anhydride, cyclic acid anhydrides are preferred. Specific examples of the cyclic acid anhydrides include phthalic anhydride, tetrahydrophthalic anhydride, hexahydrophthalic anhydride, 3,6-endoxy-tetrahydrophthalic anhydride, tetrachlorophthalic anhydride, maleic anhydride, chloromaleic anhydride, a-phenylmaleic anhydride, succinic anhydride and pyromellitic anhydride as described in U.S. Pat. No. 4,115,128. Examples of acyclic acid anhydrides include acetic anhydride.

Examples of the phenols include, bisphenol A, 2,2′-bishydroxysulfone, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane, and the like.

Additionally, examples of the organic acids include the sulfonic acids, sulfinic acids, alkylsulfuric acids, phosphonic acids, phosphoric acid esters and carboxylic acids described in JP-A Nos. 60-88942 and 2-96755, and others, and specific examples thereof include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluyl acid, 3,4-dimethoxybenzoic acid, phthalic acid, terephthalic acid, 4-cyclohexene-1,2-dicarboxylic acid, erucic acid, lauric acid, n-undecane acid, ascorbic acid, and the like.

The content of the acid anhydride, the phenol compound and the organic acid in the lower layer or the upper layer is preferably from 0.05 to 20% by mass, more preferably from 0.1 to 15% by mass, and particularly preferably from 0.1 to 10% by mass, based on the respective total solid content of the lower layer or the upper layer.

(Surfactant)

For improvement of coatability and enhancement of stability of processing with respect to developing conditions, the upper layer and/or the lower layer of the recording layer of the invention may contain a nonionic surfactant such as those disclosed in JP-A Nos. 62-251740 and 3-208514, an amphoteric surfactant such as those disclosed in JP-A Nos. 59-121044 and 4-13149, a siloxane compound such as those disclosed in EP-A No. 950517, and a copolymer of fluorine-containing monomers as disclosed in JP-A Nos. 62-170950 and 11-288093 and Japanese Patent Application No. 2001-247351.

Specific examples of the nonionic surfactant include sorbitan tristearate, sorbitan monopalmitate, sorbitan trioleate, monoglyceride stearate, and polyoxyethylene nonyl phenyl ether. Specific examples of the amphoteric surfactant include alkyldi(aminoethyl)glycine, alkylpolyaminoethylglycine hydrochloride, 2-alkyl-N-carboxyethyl-N-hydroxyethylimidazolium betaine, and N-tetradecyl-N,N-betaine type surfactants (trade name: “Amorgen K”, manufactured by Daiichi Kogyo Co., Ltd., and others).

The siloxane compound is preferably a block copolymer of dimethylsiloxane and polyalkylene oxide. Specific examples thereof include polyalkylene oxide modified silicones (trade names: DBE-224, DBE-621, DBE-712, DBP-732 and DBP-534 (trade name, manufactured by Chisso Corp.), and Tego Glide 100 (trade name, manufactured by Tego Co. in Germany)).

The content of the nonionic surfactant and the amphoteric surfactant in the lower layer or the upper layer is preferably from 0.01 to 15% by mass, more preferably from 0.1 to 5% by mass, and even more preferably from 0.05 to 0.5% by mass, based on the total solid content in the lower layer or the upper layer, respectively.

(Printing-Out Agent/Image Coloring Agent)

The upper layer and/or the lower layer of the recording layer of the invention may contain a printing-out agent for obtaining visible images immediately after heating by exposure, and a dye and a pigment may be added as an image coloring agent.

A typical example of the printing-out agent is a combination of a compound which releases an acid by being heated by exposure to light (optically acid-releasing agent) with an organic dye which can form a salt. Specific examples thereof include combinations of o-naphthoquinonediazide-4-sulfonic acid halogenide with a salt-formable organic dye, described in JP-A Nos. 50-36209 and 53-8128; and combinations of a trihalomethyl compound with a salt-formable organic dye, described in JP-A Nos. 53-36223, 54-74728, 60-3626, 61-143748, 61-151644 and 63-58440. The trihalomethyl compound is an oxazole type compound or a triazine type compound. Either of these compounds are excellent in stability over time and can give vivid printed-out images.

The image coloring agent may be the above-mentioned salt-formable organic dye or some other dye than the salt-formable organic dye, and is preferably an oil-soluble dye or a basic dye. Specific examples thereof include Oil Yellow # 101, Oil Yellow # 103, Oil Pink #312, Oil Green BG, Oil Blue BOS, Oil Blue #603, Oil Black BY, Oil Black BS, and Oil Black T-505 (trade name, manufactured by Orient Chemical Industries Ltd.), Victoria Pure Blue, Crystal Violet Lactone, Crystal Violet (CI42555), Methyl Violet (CI42535), Ethyl Violet, Rhodamine B (CI145170B), Malachite Green (CI42000), and methylene Blue (CI52015). Dyes described in JP-A No. 62-293247 are particularly preferable.

These dyes may be added to the lower layer or the upper layer in an amount of from 0.01 to 10% by mass, and preferably from 0.1 to 3% by mass, based on the total solid content in the lower layer or the upper layer, respectively.

(Plasticizer)

The upper layer and/or the lower layer of the recording layer of the invention may contain a plasticizer for imparting flexibility to a coating film. Examples thereof include butylphthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl oleate and an oligomer or a polymer of acrylic acid or methacrylic acid.

The plasticizer may be added to the lower layer and/or the upper layer in an amount of from 0.5 to 10% by mass, and preferably from 1.0 to 5% by mass, based on the total solid content of the lower layer or the upper layer, respectively.

(Wax)

To the upper layer of the invention, a compound that lowers a static friction coefficient of the surface may be added in order to impart scratch resistance. Specific examples of the compound include compounds having an ester of a long-chain alkyl carboxylic acid as disclosed in U.S. Pat. No. 6,117,913 and Japanese Patent Application Nos. 2001-261627, 2002-032904 and 2002-165584. The amount of the wax added is preferably from 0.1 to 10% by mass, and more preferably from 0.5 to 5% by mass, based on the weight of the upper layer.

[Formation of Recording Layer]

The lower layer and the upper layer of the recording layer of the planographic printing plate precursor according to the invention may be formed by dissolving the aforementioned components in a solvent, and applying a coating on an appropriate support.

Examples of the solvent that may be used herein include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone and toluene, but the invention is not limited to these. These solvents may be used independently or in combination of two or more thereof.

In principle, it is desirable to form the lower layer and the upper layer separately from each other.

Examples of the method for forming the two layers separately include a method that utilizes a difference in solubility in the solvent between the components contained in the lower layer and the components contained in the upper layer, and a method in which the upper layer is coated and then quickly dried to remove the solvent.

These methods will be described below, but the method for coating the two layers separately is not limited thereto.

In the method utilizing the difference in solubility in solvent between the components contained in the lower layer and the components contained in the upper layer, a solvent system that does not dissolve all the components contained in the lower layer is employed for coating the coating solution for the upper layer. According to this method, the two layers can clearly be formed as separate coated films even when conducting a double-layer coating.

For example, components that are insoluble in a solvent capable of dissolving the alkali-soluble resin component of the upper layer such as methyl ethyl ketone and 1-methoxy-2-propanol solvents, are employed as components of the lower layer, and the lower layer is coated and dried by using a solvent system that dissolves the components of the lower layer. Thereafter, the components of the upper layer containing the alkali-soluble resin as a main component are dissolved, coated and dried by using a solvent that does not dissolve the lower layer, such as methyl ethyl ketone and 1-methoxy-2-propanol, whereby the two layers are separately formed.

Examples of the method of quickly drying the solvent after coating the upper layer include a method of blowing high-pressure air from a slit nozzle disposed substantially perpendicular to the running direction of the web, a method of applying heat energy to the lower surface of the web through a roll (heating roll) to which a heating medium, such as steam, is internally fed, and a method combining these methods.

In order to impart a new function, the lower layer and the upper layer may be partially admixed to such an extent that the effect of the invention remains sufficiently exhibited. The partial admixture can be achieved by controlling the difference in solubility in solvent in the method utilizing the difference in solubility between the layers or controlling the drying rate in the method in which the upper layer is coated and then quickly dried to remove the solvent.

The concentration of the components other than the solvent (total solid content including the additives) in the lower layer and upper layer coating solutions to be coated on the support is preferably from 1 to 50% by mass, respectively.

There are various possible methods for coating the coating composition on the support. Examples thereof include bar coater coating, spin coating, spray coating, curtain coating, dip coating, air knife coating, blade coating and roll coating.

In order to prevent the lower layer from being damaged upon coating the upper layer, the coating method is preferably a non-contact coating method. Bar coater coating, which is generally used for solvent-based coating, could be used in the invention, although bar coater coating is a contact coating method. However, when bar coater is used, it is preferable that the bar coater coating is effected by forward rotation in order to prevent damage to the lower layer.

The amount, after drying, of the lower layer component coated on the support of the planographic printing plate precursor of the invention is preferably within the range of from 0.5 to 4.0 g/m², and more preferably in a range of from 0.6 to 2.5 g/m². An amount less than 0.5 g/m² is undesirable because it may cause deterioration in printing durability. An amount over 4.0 g/m² is also undesirable because it may cause deterioration in image reproducibility or reduction in sensitivity.

The amount of the upper layer component after drying is preferably within the range of from 0.05 to 1.0 g/m², and more preferably in a range of from 0.08 to 0.7 g/m². An amount less than 0.05 g/m² is undesirable because it may cause deterioration in development latitude and scratch resistance. An amount over 1.0 g/m² is also undesirable because it may cause reduction in sensitivity.

The total amount of the lower and upper layers after drying is preferably within the range of from 0.6 to 4.0 g/m², and more preferably in a range of from 0.7 to 2.5 g/m². An amount less than 0.6 g/m² is undesirable because it may cause deterioration in printing durability. An amount over 4.0 g/m² is also undesirable because it may cause deterioration in image reproducibility or reduction in sensitivity.

[Support]

The support which is used in the planographic printing plate precursors of the invention may be any plate-form product that has necessary strength and endurance and is dimensionally stable. Examples thereof include a paper sheet; a paper sheet on which a plastic (such as polyethylene, polypropylene, or polystyrene) is laminated; a metal plate (such as an aluminum, zinc, or copper plate), a plastic film (such as a cellulose diacetate, cellulose triacetate, cellulose propionate, cellulose lactate, cellulose acetate lactate, cellulose nitrate, polyethylene terephthalate, polyethylene, polystyrene, polypropylene, polycarbonate, or polyvinyl acetal film); and a paper or plastic film on which a metal as described above is laminated or vapor-deposited.

Of these supports, a polyester film or an aluminum plate is preferable in the invention. An aluminum plate is particularly preferable since the plate is good in dimensional stability and relatively inexpensive. Preferable examples of the aluminum plate include a pure aluminum plate, and alloy plates comprising aluminum as the main component and a small amount of different elements. A plastic film on which aluminum is laminated or vapor-deposited may be used. Examples of the different elements contained in the aluminum alloy include silicon, iron, manganese, copper, magnesium, chromium, zinc, bismuth, nickel, and titanium. The content by percentage of the different elements in the alloy is at most 10% by mass.

In the invention, pure aluminum is particularly preferable. However, completely pure aluminum is not easily produced from the viewpoint of metallurgy technology. Thus, aluminum containing a trance amount of the different elements may be used.

As described above, the aluminum plate used in the invention, the composition of which is not specified, may be any aluminum plate that has been known or used hitherto. The thickness of the aluminum plate used in the invention is generally from about 0.1 to 0.6 mm, preferably from 0.15 to 0.4 mm, and more preferably from 0.2 to 0.3 mm.

The aluminum plate may be subjected, depending on necessity, to a surface treatment, such as a surface roughening treatment and an anodic oxidation treatment. The surface treatment will be described below.

Before the surface of the aluminum plate is roughened, the plate is subjected to degreasing treatment with a surfactant, an organic solvent, an aqueous alkaline solution or the like if desired, in order to remove rolling oil on the surface. The roughening treatment of the aluminum plate surface is performed by any one of various methods, for example, by a mechanically surface-roughening method, or a method of dissolving and roughening the surface electrochemically, or a method of dissolving the surface selectively in a chemical manner.

The mechanically surface-roughening method which can be used may be a known method, such as a ball polishing method, a brush polishing method, a blast polishing method or a buff polishing method. The electrochemically surface-roughening method may be a method of performing surface-roughening in a hydrochloric acid or nitric acid electrolyte by use of alternating current or direct current. As disclosed in JP-A No. 54-63902, a combination of the two may be used.

The aluminum plate the surface of which is roughened as described above is subjected to alkali-etching treatment and neutralizing treatment if necessary. Thereafter, the aluminum plate is subjected to anodizing treatment if desired, in order to improve the water holding ability or wear resistance of the surface. The electrolyte used in the anodizing treatment of the aluminum plate is any one selected from various electrolytes which can make a porous oxide film. There is generally used sulfuric acid, phosphoric acid, oxalic acid, chromic acid, or a mixed acid thereof. The concentration of the electrolyte may be appropriately decided dependently on the kind of the electrolyte.

Conditions for the anodizing treatment cannot be specified without reservation since the conditions vary dependently on the used electrolyte. The following conditions are generally suitable: an electrolyte concentration of 1 to 80% by mass, a solution temperature of 5 to 70° C., a current density of 5 to 60 A/dm², a voltage of 1 to 100 V, and an electrolyzing time of 10 seconds to 5 minutes. If the amount of the anodic oxide film is less than 1.0 g/m², the printing durability is insufficient or non-image areas of the planographic printing plate are easily injured so that the so-called “injury stains”, resulting from ink adhering to injured portions at the time of printing, are easily generated.

If necessary, the aluminum surface is subjected to treatment for hydrophilicity after the anodizing treatment.

The treatment for hydrophilicity which can be used in the invention may be an alkali metal silicate (for example, aqueous sodium silicate solution) method, as disclosed in U.S. Pat. Nos. 2,714,066,3,181,461, 3,280,734, and 3,902,734. In this method, the support is subjected to immersing treatment or electrolyzing treatment with aqueous sodium silicate solution. Besides, there may be used a method of treating the support with potassium fluorozirconate disclosed in JP-B No. 36-22063 or with polyvinyl phosphonic acid, as disclosed in U.S. Pat. Nos. 3,276,868, 4,153,461, and 4,689,272.

In the planographic printing plate precursor according to the invention, an undercoat layer may be provided, as necessary, between the support and the recording layer.

As components for the undercoat layer, various organic compounds may be used. Examples thereof include carboxymethylcellulose, dextrin, gum arabic, phosphonic acids having an amino group such as 2-aminoethylphosphonic acid, organic phosphonic acids such as phenylphosphonic acid, naphthylphosphonic acid, alkylphosphonic acid, glycerophosphonic acid, methylenediphosphonic acid and ethylenediphosphonic acid, each of which may have a substituent, organic phosphoric acids such as phenylphosphoric acid, naphthylphosphoric acid, alkylphosphoric acid and glycerophosphoric acid, each of which may have a substituent, organic phosphinic acids such as phenylphosphinic acid, naphthylphosphinic acid, alkylphosphinic acid, and glycerophosphinic acid, each of which may have a substituent, amino acids such as glycine and β-alanine, and hydrochlorides of amines having a hydroxyl group, such as hydrochloride of triethanolamine. These may be used in a mixture form.

This organic undercoat layer can be formed by the following method: a method of dissolving the above-mentioned organic compound into water, an organic solvent such as methanol, ethanol or methyl ethyl ketone, or a mixed solvent thereof to prepare a solution, applying the solution onto an aluminum plate, and drying the solution to form the undercoat layer; or a method of dissolving the above-mentioned organic compound into water, an organic solvent such as methanol, ethanol or methyl ethyl ketone, or a mixed solvent thereof to prepare a solution, dipping an aluminum plate into the solution to cause the plate to adsorb the organic compound, washing the plate with water or the like, and then drying the plate to form the undercoat layer.

In the former method, the solution of the organic compound having a concentration of 0.005 to 10% by mass can be applied by various methods. In the latter method, the concentration of the organic compound in the solution is from 0.01 to 20% by mass, preferably from 0.05 to 5% by mass, the dipping temperature is from 20 to 90° C., preferably from 25 to 50° C., and the dipping time is from 0.1 second to 20 minutes, preferably from 2 seconds to 1 minute.

The pH of the solution used in this method can be adjusted into the range of 1 to 12 with a basic material such as ammonia, triethylamine or potassium hydroxide, or an acidic material such as hydrochloric acid or phosphoric acid. A yellow dye can be added to the solution in order to improve the reproducibility of the tone of the image recording material.

The coated amount of the organic undercoat layer is appropriately from 2 to 200 mg/m², and preferably from 5 to 100 mg/m². In cases where the coated amount is less than 2 mg/m² or exceeds 200 mg/m², sufficient printing durability may not be obtained.

The planographic printing plate precursor thus produced is exposed imagewise and then subjected to a developing treatment.

[Exposure]

Examples of the light source of the active rays used for image exposure of the planographic printing plate precursor of the invention include a mercury lamp, metal halide lamp, xenon lamp, chemical lamp and carbon arc lamp. Examples of the radioactive rays used for image exposure of the planographic printing plate precursor of the invention include electron rays, X-rays, ion beams and far infrared radiation. G-rays, i-rays, Deep-UV light and high-density energy beams (laser beams) may also be used.

Examples of the laser beam include helium·neon laser, argon laser, krypton laser, helium·cadmium laser and KrF excimer laser.

In the invention, the planographic printing plate precursor is particularly preferably exposed to light from a light source having an emitting wavelength in the near-infrared region to the infrared region. Examples of such a light source include solid laser or semiconductor laser.

[Developing Treatment]

A conventionally known alkali developer which contains an organic compound having a buffering activity and a base as major ingredients and which is substantially free of silicon dioxide can be used as a developer and also as a replenisher for the development of the planographic printing plate precursor of the invention. In the invention, such a developer is hereinafter referred to as a “non-silicate developer.” Herein, “substantially” means that the presence of unavoidable impurities and a minor amount of silicate dioxide as a side product is acceptable.

By the application of such a non-silicate developer to a step of developing the planographic printing plate precursor of the invention, the effect of inhibiting scratch generation is exhibited and an excellent planographic printing plate having no defects in the image portion can be obtained. An aqueous alkali solution having pH 12.5 to 13.5 is particularly preferable.

The “non-silicate developer” used in the development of the planographic printing plate precursor of the invention is a solution containing a base and an organic compound having a buffering activity as main components as described above. Examples of the organic compound having a buffering activity include sugars which are described as compounds providing a buffer action in JP-A No. 8-220775 (particularly those represented by formulae (I) or (II)), oximes (particularly those represented by formula (III)), phenols (particularly those represented by formula (IV)) and fluorinated alcohols (particularly those represented by formula (V)). Among the compounds represented by formulae (I) to (V), the sugars represented by formulae (I) and (II) and the phenols represented by formula (V) are preferred. Among the sugars of formulae (I) and (II), non-reducing sugars, such as saccharose, and sulfosalysilic acid are particularly preferred. The non-reducing sugars include trehalose-type oligosaccharides in which reducing groups are bonded to each other, glycosides in which a reducing group of a sugar and a non-sugar compound are bonded to each other, and sugar alcohols obtained by reducing sugars by hydrogenation. Any of these organic compounds can be used suitably for the invention.

Examples of the trehalose type oligosaccharides include saccharose and trehalose. Examples of the glucosides include alkylglucosides, phenolglucosides, and mustard seed oil glucoside.

Examples of the sugar alcohols include D, L-arabite, ribitol, xylitol, D, L-sorbitos, D, L-mannitol, D, L-iditol, D, L-talitol, dulcitol, and allodulcitol.

Furthermore, maltitol, obtained by hydrogenating a disaccharide, and a reductant obtained by hydrogenating an oligosaccharide (i.e., reduced starch syrup) are preferable.

Of these examples, sugar alcohol and saccharose are more preferable. D-sorbitol, saccharose, and reduced starch syrup are even more preferable since they have buffer effect within an appropriate pH range and are inexpensive.

These nonreducing sugars may be used alone or in combination of two or more thereof. The percentage thereof in the developer is preferably from 0.1 to 30% by mass, more preferably from 1 to 20% by mass.

An appropriate conventional alkali agent may be combined, as a base, with the above-described organic compounds having buffering effect.

Examples of the alkali agent include inorganic alkali agents such as sodium hydroxide, potassium hydroxide, lithium hydroxide, trisodium phosphate, tripotassium phosphate, triammonium phosphate, disodium phosphate, dipotassium phosphate, diammonium phosphate, sodium carbonate, potassium carbonate, ammonium carbonate, sodium hydrogencarbonate, potassium hydrogencarbonate, ammonium hydrogencarbonate, sodium borate, potassium borate, ammonium borate, potassium citrate, tripotassium citrate and sodium citrate; and organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine. The bases may be used alone or in combination of two or more.

Among these bases, sodium hydroxide and potassium hydroxide are preferred, because the pH can be regulated across a wide pH range by adjusting the amount added relative to the non-reducing sugar.

Trisodium phosphate, tripotassium phosphate, sodium carbonate and potassium carbonate are also preferred because they inherently possess a buffering activity.

In an automated developing machine, a conventionally employed replenishing system is known to be able to process a large amount of planographic printing plates without exchanging the developer in the tank for a long period of time by adding, to a developer, an aqueous solution (replenisher) having an alkali strength higher than that of the developer. This replenishing system is suitably used also in the invention. If necessary, the developer and the replenisher may contain a surfactant or an organic solvent for such purposes as increasing or decreasing developability, dispersing the sludge resulting from development, and increasing the ink affinity of the image areas of a printing plate. Examples of preferable surfactants include anionic surfactants, cationic surfactants, nonionic surfactants, and amphoteric surfactants. If necessary, the developer and the replenisher may contain a reducing agent such as hydroquinone, resorcinol, and sodium and potassium salts of inorganic acids such as sulfurous acid and hydrogensulfurous acid, or, further, an organic carboxylic acid, a defoaming agent or a water softener.

The printing plate developed with the developer and replenisher described above is subsequently subjected to treatments with washing water, a rinse solution containing a surfactant and other components, and a desensitizing solution containing gum arabic and a starch derivative. In such a post treatment for the planographic printing plate precursor of the invention, various combinations of the aforementioned treatments may be employed.

In recent years, automatic developing machines for printing plate precursors have been widely used in order to rationalize and standardize plate-making processes in the plate-making and printing industries. These automatic developing machines are generally made up of a developing section and a post-processing section, and include a device for carrying printing plate precursors, various treating solution tanks, and spray devices. These machines are machines for spraying respective treating solutions, which are pumped up, onto an exposed printing plate through spray nozzles, for development, while the printing plate is transported horizontally.

Recently, a method has also attracted attention in which a printing plate precursor is immersed in treating solution tanks filled with treating solutions and conveyed by means of in-liquid guide rolls. Such automatic processing can be performed while replenishers are being replenished into the respective treating solutions in accordance with the amounts to be treated, operating times, and other factors. A so-called use-and-dispose processing manner can also be used, in which treatments are conducted with treating solutions which in practice have yet been used.

In the planographic printing plate precursor of the invention, if unnecessary image portions (for example, a film edge mark of an original picture film) are present on a planographic printing plate obtained by exposing imagewise to light the planographic printing plate precursor of the invention, developing the exposed precursor, and subjecting the developed precursor to water-washing and/or rinsing and/or desensitizing treatment(s), unnecessary image portions can be erased.

The erasing is preferably performed by applying an erasing solution to unnecessary image portions, leaving the printing plate as it is for a given time, and washing the plate with water, as described in, for example, JP-B No. 2-13293. This erasing may also be performed by a method of radiating active rays introduced through an optical fiber onto the unnecessary image portions, and then developing the plate, as described in JP-A No. 59-174842.

The planographic printing plate obtained as described above is, if desired, coated with a desensitizing gum, and subsequently the plate can be made available for a printing step. When it is desired to make a planographic printing plate have a higher degree of printing resistance, baking treatment is applied to the planographic printing plate.

In a case where the planographic printing plate is subjected to the baking treatment, it is preferable that before the baking treatment takes place the plate is treated with a surface-adjusting solution as described in JP-B No. 61-2518, or JP-A Nos. 55-28062, 62-31859 or 61-159655.

This method of treatment is, for example, a method of applying the surface-adjusting solution onto the planographic printing plate with a sponge or absorbent cotton infiltrated with the solution, a method of immersing the planographic printing plate in a vat filled with the surface-adjusting solution, or a method of applying the surface-adjusting solution to the planographic printing plate with an automatic coater. In a case where after application the amount of solution applied is made uniform with a squeegee or a squeegee roller, a better result can be obtained.

In general, the amount of surface-adjusting solution applied is suitably from 0.03 to 0.8 g/m² (dry mass). If necessary the planographic printing plate onto which the surface-adjusting solution is applied can be dried, and then the plate is heated to a high temperature by means of a baking processor (for example, a baking processor (BP-1300) sold by Fuji Photo Film Co., Ltd.) or the like. In this case the heating temperature and the heating time, which depend on the kind of components forming the image, are preferably from 180 to 300° C. and from 1 to 20 minutes, respectively.

If necessary, a planographic printing plate subjected to baking treatment can be subjected to treatments which have been conventionally conducted, such as a water-washing treatment and gum coating. However, in a case where a surface-adjusting solution containing a water soluble polymer compound or the like is used, the so-called desensitizing treatment (for example, gum coating) can be omitted. The planographic printing plate obtained as a result of such treatments is applied to an offset printing machine or to some other printing machine, and is used for printing on a great number of sheets.

### EXAMPLES

Hereinafter, the invention will be described by reference to the following examples. However, the invention is not limited to these examples.

[Preparation of Specified Phenol Resin]

### Synthesis Example 1

Into a 200-ml flask fitted with a stirrer and a heating device, 30 g of methanol and 5 g of N,N-dimethylacetamide were charged. Subsequently, 13.87 g (0.126 mole) of catechol and 13.76 g (0.115 mole) of N,N′-dimethylol urea were added. While the mixture was stirred at room temperature, 6 g of concentrated hydrochloric acid (12 N) was added and then heating was started. When the temperature reached 55° C., the temperature was maintained and the mixture was allowed to react at 55-60° C. for 5 hours. When the reaction solution was poured into 400 ml of water while stirring, a pale yellow solid formed. The solid was separated by filtration and dried. Thus, 20 g of specified phenol resin (1) was obtained. The yield was 72%.

### Synthesis Examples 2-4

Resins were obtained in the same manner as in Synthesis Example 1 except that one of the starting materials, 13.87 g (0.126 mole) of catechol, was changed to 15.64 g (0.126 mole) of 3-methylcatechol, 15.64 g (0.126 mole) of 4-methylcatechol, and 17.64 g (0.126 mole) of 3-methoxycatechol, respectively. 25 g of specified phenol resin (2) (yield 85%), 23 g of specified phenol resin (3) (yield 78%) and 22 g of specified phenol resin (4) (yield 75%) were respectively obtained.

### Synthesis Example 5

Into a 500-ml flask fitted with a stirrer and a heating device, 150 g of methanol and 15 g of water were charged. Subsequently, 63.05 g (0.50 mole) of pyrogallol and 50.0 g (0.45 mole) of N,N′-dimethylol urea were added and dissolved while stirring. 7.0 g of concentrated hydrochloric acid (12 N) was added to the mixture and then heating was started. When the temperature reached 55° C., the temperature was maintained and the mixture was allowed to react at 55-60° C. for 7 hours. After completion of the reaction the reaction solution was poured into 1000 ml of water while stirring. The solid formed was separated by filtration and dried. Thus, 89 g of specified phenol resin (5) was obtained. The yield was 79%.

### Synthesis Example 6>

Into a 200-ml flask fitted with a stirrer, a silica gel drying tube and a heating device, 100 ml of dry N,N-dimethylacetamide was charged. Subsequently, 5.0 g of specified phenol resin (1) obtained in Synthesis Example 1 was added and dissolved at room temperature while stirring. To this mixture, 5.0 g (1.7 molar equivalents for two hydroxyl groups of catechol) of phenyl isocyanate was added and, further, three drops of di-n-butyl tin dilaurate and three drops of triethylamine were added. The resulting mixture was allowed to react at 50° C. for 2 hours. The reaction solution after completion of the reaction was poured into 1000 ml of water while stirring. The solid formed was separated by filtration and dried. Thus, 8.0 g of specified phenol resin (6) was obtained. The yield was 80%.

### Synthesis Example 7

Into a 200-ml flask fitted with a stirrer and a silica gel drying tube, 100 ml of dry N,N-dimethylacetamide was charged. Subsequently, 5.0 g of specified phenol resin (1) obtained in Synthesis Example 1 was added and dissolved at room temperature while stirring. To this mixture, 2.5 g (1.0 molar equivalent for two hydroxyl groups of catechol) of p-toluenesulfonyl chloride was added and, further, 2.0 g of triethylamine was added. The resulting mixture was allowed to react at room temperature overnight while stirring. The reaction solution after completion of the reaction was poured into 1000 ml of water while stirring. Then, the solution was acidified by addition of a few drops of a 65% aqueous sulfuric acid solution. The solid formed from the reaction solution was separated by filtration. Thus, 6.0 g of specified phenol resin (7) was obtained. The yield was 80%.

### Synthesis Example 8

7.0 g of specified phenol resin (8) was obtained in the same manner as Synthesis Example 7 except that the amount of the p-toluenesulfonyl chloride added was changed to 4.0 g (1.6 molar equivalents for two hydroxyl groups of catechol) and the amount of the triethylamine added was changed to 3.0 g. The yield was 78%.

### Synthesis Example 9

Into a 200-ml flask fitted with a stirrer and a silica gel drying tube, 100 ml of dry N,N-dimethylacetamide was charged. Subsequently, 3.0 g of specified phenol resin (5) obtained in Synthesis Example 5 was added and dissolved at room temperature while stirring. To this mixture, 6.0 g (2.2 molar equivalents for three hydroxyl groups of pyrogallol) of p-toluenesulfonyl chloride was added and, further, 4.6 g of triethylamine was added. The resulting mixture was allowed to react at room temperature overnight while stirring. The reaction solution after completion of the reaction was poured into 1000 ml of water while stirring. Then, the solution was acidified by addition of a few drops of a 65% aqueous sulfuric acid solution. The solid formed from the reaction solution was separated by filtration. Thus, 7.0 g of specified phenol resin (9) was obtained. The yield was 87%.

### Synthesis Example 10

7.2 g of specified phenol resin (10) was obtained in the same manner as Synthesis Example 9 except that the amount of the p-toluenesulfonyl chloride added was changed to 8.2 g (3.0 molar equivalents for three hydroxyl groups of pyrogallol) and the amount of the triethylamine added was changed to 6.8 g. The yield was 75%.

### Synthesis Example 11

Into a 200-ml flask fitted with a stirrer and a silica gel drying tube, 150 ml of dry N,N-dimethylacetamide was charged. Subsequently, 12.2 g of specified phenol resin (5) obtained in Synthesis Example 5 was added and dissolved at room temperature while stirring. To this mixture, 5.0 g (1.5 molar equivalents for three hydroxyl groups of pyrogallol) of 3-nitrobenzyl chloride was added and, further, 3.5 g of triethylamine was added. The resulting mixture was allowed to react at room temperature overnight while stirring. The reaction solution after completion of the reaction was poured into 1000 ml of water while stirring. Then, the solution was acidified by addition of a few drops of a 65% aqueous sulfuric acid solution. The solid formed from the reaction solution was separated by filtration and dried. Thus, 12.0 g of specified phenol resin (11) was obtained. The yield was 73%.

### Synthesis Example 12

Into a 200-ml flask fitted with a stirrer and a silica gel drying tube, 150 ml of dry N,N-dimethylacetamide was charged. Subsequently, 5.0 g of specified phenol resin (5) obtained in Synthesis Example 5 was added and dissolved at room temperature while stirring. To this mixture, 1.85 g (1.5 molar equivalents for three hydroxyl groups of pyrogallol) of p-toluoyl chloride was added and, further, 1.5 g of triethylamine was added. The resulting mixture was allowed to react at room temperature overnight while stirring. The reaction solution after completion of the reaction was poured into 1000 ml of water while stirring. Then, the solution was acidified by addition of a few drops of a 65% aqueous sulfuric acid solution. The solid formed from the reaction solution was separated by filtration and dried. Thus, 4.3 g of specified phenol resin (12) was obtained. The yield was 55%.

### Example 1

[Preparation of Support]

A 0.24 mm-thick aluminum sheet (aluminum alloy containing 0.06% by weight of Si, 0.30% by weight of Fe, 0.014% by weight of Cu, 0.001% by weight of Mn, 0.001% by weight of Mg, 0.001% by weight of Zn, and 0.03% by weight of Tᵢ, with the remainder being Al and inevitable impurities) was consecutively subjected to the following surface treatments.

The surface of the aluminum sheet was continuously subjected to electrochemical roughening treatment using an alternating current voltage of 60 Hz. Here, the electrolyte was an aqueous solution of 10 g/L of nitric acid (containing 5 g/L of aluminum ions and 0.007% by mass of ammonium ions) at a temperature of 80° C. After rinsing with water, the aluminum sheet was subjected to etching treatment by spraying with a sodium hydroxide concentration of 26% by weight and an aluminum ion concentration of 6.5% by weight at a temperature of 32° C. and dissolved in an amount of 0.20 g/m², followed by rinsing with water by spraying. Thereafter, the resulting aluminum sheet was subjected to desmutting treatment by spraying with an aqueous solution having a sulfuric acid concentration of 25% by weight at a temperature of 60° C. (containing 0.5% by mass of aluminum ions) and then rinsed with water by spraying.

Next, the resulting aluminum sheet was subjected to anodic oxidation treatment using an anodic oxidation device for two-stage feeding electrolysis. As the electrolyte to be fed to the electrolysis part, sulfuric acid was used. Thereafter, the aluminum sheet was rinsed with water by spraying. A final oxidized film amount was 2.7 g/m².

The aluminum sheet subjected to the anodic oxidation treatment was then subjected to treatment with an alkali metal silicate (silicate treatment) by immersion into an aqueous solution of 1% by weight of No. 3 sodium silicate at a temperature of 30° C. for 10 seconds. Thereafter, the aluminum sheet was rinsed with water by spraying.

The silicate-treated aluminum sheet thus obtained was coated with an undercoating solution having the following composition and was dried at 80° C. for 15 seconds to form an undercoat film having a coverage after drying of 15 mg/m² to form a support A.

<Composition of Undercoating Solution>

| | | |
|---|---|---|
| Compound shown below | 0.3 | g |
| Methanol | 100 | g |
| Water | 1 | g |

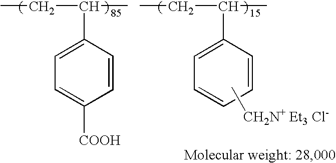

The support in web form obtained above was coated with a lower layer coating solution 1 having the following formulation using a bar coater to give a coating amount of 0.85 g/m² and then dried at 160° C. for 44 seconds, and it was immediately cooled by cold blasting at 17 to 20° C. until the temperature of the support decreased to 35° C.

Thereafter, an upper layer coating solution 1 having the following composition was applied using a bar coater to give a coating amount of 0.22 g/m² and was dried at 148° C. for 25 seconds. Then it was cooled gradually by cold blasting at 20 to 26° C. Thus, a planographic printing plate precursor of Example 1 was formed.

<Lower Layer Coating Solution 1>

| | | |
|---|---|---|
| Specified phenol resin (1) obtained in Synthesis Example 1 | 2.133 | g |
| Cyanine dye A (with the structure shown below) | 0.134 | g |
| 4,4′-bishydroxyphenylsulfone | 0.126 | g |
| Tetrahydrophthalic anhydride | 0.190 | g |
| p-Toluenesulfonic acid | 0.008 | g |
| 3-Methoxy-4-diazodiphenylamine hexafluorophosphate | 0.032 | g |
| Ethyl Violet in which | 0.781 | g |
| the counter ion has been replaced by | | |
| 6-hydroxynaphthalene sulfonic acid | | |
| Polymer 1 (with the structure shown below) | 0.035 | g |
| γ-Butyrolactone | 52.40 | g |
| 1-Methoxy-2-propanol | 17.60 | g |

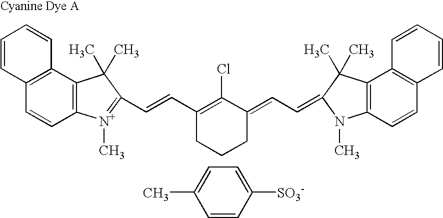

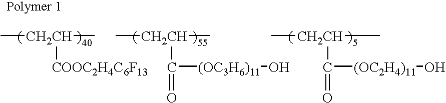

<Upper Layer Coating Solution 1>

| | | |
|---|---|---|
| m,p-Cresol Novolak | 0.3479 | g |
| (m/p molar ratio: 6/4, | | |
| weight-average molecular weight: 4500, | | |
| content of unreacted cresol: 0.8% by weight) | | |
| Cyanine Dye A (with the structure shown above) | 0.0192 | g |
| Ethyl methacrylate/ | 0.1403 | g |
| isobutyl methacrylate/acrylic acid copolymer | | |
| (37/37/26 wt %) 30% MEK solution | | |
| Polymer 1 (with the structure shown above) | 0.015 | g |
| Polymer 2 (with the structure shown below) | 0.00328 | g |
| Methyl ethyl ketone | 13.07 | g |
| 1-Methoxy-2-propanol | 6.79 | g |

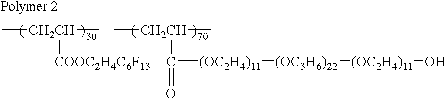

### Examples 2-11

Planographic printing plate precursors of Examples 2-11 were prepared in the same manner as in Example 1 except that the specified phenol resin (1) used in the lower layer coating solution 1 (indicated as (Synthesis Example 1) in Table 1; other resins referred to hereafter are indicated in the same way) was changed to specified phenol resins (2)-(4) and (6)-(12) obtained in the Synthesis Examples described above.

### Comparative Example 1

A planographic printing plate precursor of Comparative Example 1 was prepared in the same manner as in Example 1 except that the polyurethane resin used in the lower layer coating solution 1 was changed to the comparative compound [N-(4-aminosulfonylphenyl)methacrylamide/acrylonitrile/methyl methacrylate (36/34/30: weight-average molecular weight 50000, acid value 2.65)].

[Evaluation of Planographic Printing Plate Precursor]

(Evaluation of Printing Durability)

A test pattern image was formed on the planographic printing plate precursors of Examples 1 to 11 and the planographic printing plate precursor of Comparative Example 1 by varying the exposure energy with Trendsetter manufactured by Creo Products Inc. Thereafter, the planographic printing plates, developed with a developer DT-2 manufactured by Fuji Photo Film Co., Ltd. (diluted to have an electric conductivity 43 of mS/cm), were subjected to continuous printing using a printing machine LITHRONE manufactured by Komori Corporation. The printing resistance was evaluated by visually measuring the number of sheets printed with a sufficient ink concentration, such that the larger the number of sheets measured, the better the evaluation of printing durability. The results are shown in Table 1 below.

(Evaluation of Chemical Resistance)

The planographic printing plate precursors of Examples 1 to 11 and the planographic printing plate precursor of Comparative Example 1 were subjected to exposure, development and printing in the same manner as that used in the evaluation of printing durability described above. A step of wiping the plate surface with a cleaner (MULTICLEANER, manufactured by Fuji Photo Film Co., Ltd.) was added every 5,000 sheets of printing to evaluate chemical resistance. The chemical resistance was evaluated by visually measuring the number of sheets printed with a sufficient ink concentration, such that the larger the number of sheets measured, the better the evaluation of chemical resistance. The results are shown in Table 1 below.

(Evaluation of Halftone Dot Printing Durability)

The planographic printing plate precursors of Examples 1 to 11 and the planographic printing plate precursor of Comparative Example 1 were subjected to scanning exposure at a beam strength of 9 W and a drum speed of 150 rpm to form 0.5% halftone dots (highlights). The planographic printing plate precursors were then exposed and subsequently developed with the developer mentioned above. The developed planographic printing plates were subjected to continuous printing using a printing machine LITHRONE manufactured by Komori Corporation. The halftone dot printing durability was evaluated by visually measuring the number of sheets printed with a sufficient ink concentration. The larger the number of sheets, the better the evaluation of halftone dot printing durability. The results are shown in Table 1 below.

(Sharpness of Image)

A test pattern (Staccato 10) image was formed on the heat-sensitive planographic printing plates of Examples 1 to 11 and the planographic printing plate precursor of Comparative Example 1 using a Trendsetter manufactured by Creo Products Inc. at a beam strength of 9 W and a drum speed of 150 rpm. The planographic printing plate precursors 1 to 11 which had been exposed under the above conditions were developed at a solution temperature of 30° C. for a developing time of 12 seconds using a PS processor 940HII manufactured by Fuji Film Co., Ltd. containing DT-2 manufactured by Fuji Photo Film Co., Ltd. (diluted to have an electric conductivity of 43 mS/cm). Edge portions of the image obtained were observed by an electron microscope (Hitachi S-800 manufactured by Hitachi, Ltd.). The sharpness of images was evaluated according to the following standards.

<Standard of Evaluation of Image Sharpness>

A: A side of an image was straight
B: A small portion was missing from a side of an image.
C: ½ or more of a side of an image was missing
   (Evaluation of Scratch Resistance)

Each of the photosensitive planographic printing plates of Examples 1 to 11 and Comparative Example 1 was rubbed 15 times under a load of 250 g with an Abraser Felt CS5 using a rotary abrasion tester (manufactured by TOYOSEIKI).

Thereafter, each planographic printing plate was developed at a solution temperature of 30° C. for a developing time of 12 seconds using a PS processor 940HII manufactured by Fuji Film Co., Ltd. containing DT-2 manufactured by Fuji Photo Film Co., Ltd. (diluted to have an electric conductivity of 43 mS/cm). The scratch resistance was evaluated according to the following standards.

<Standards for Evaluation of Scratch Resistance>

A: Optical density of an abraded portion of the photosensitive film was not changed at all
B: A slight change of optical density of the abraded portion of the photosensitive film was visually observed

C: The optical density of the abraded portion of the photosensitive film was ⅔ or less relative to a non-abraded portion

TABLE 1

| | | | | | Printing | |
|---|---|---|---|---|---|---|
| | | Printing | Chemical | | Durability | |
| | | Durability | Resistance | Sharp- | of Halftone | |
| | Lower | (ten | (ten | ness | Dot (ten | Scratch |
| | Layer | thousand | thousand | of | thousand | Resis- |
| | Resin | sheets) | sheets) | image | sheets) | tance |
| Exam- | Synthesis | 17 | 10 | A | 15 | A |
| ple 1 | Example 1 | | | | | |
| Exam- | Synthesis | 17 | 10 | A | 15 | A |
| ple 2 | Example 2 | | | | | |
| Exam- | Synthesis | 17 | 10 | A | 15 | A |
| ple 3 | Example 3 | | | | | |
| Exam- | Synthesis | 18 | 10 | A | 16 | A |
| ple 4 | Example 4 | | | | | |
| Exam- | Synthesis | 17 | 10 | A | 15 | A |
| ple 5 | Example 6 | | | | | |
| Exam- | Synthesis | 17 | 10 | A | 15 | A |
| ple 6 | Example 7 | | | | | |
| Exam- | Synthesis | 17 | 10 | A | 15 | A |
| ple 7 | Example 8 | | | | | |
| Exam- | Synthesis | 18 | 10 | A | 16 | A |
| ple 8 | Example 9 | | | | | |
| Exam- | Synthesis | 17 | 10 | A | 15 | A |
| ple 9 | Example | | | | | |
| | 10 | | | | | |
| Exam- | Synthesis | 17 | 10 | A | 15 | A |
| ple 10 | Example | | | | | |
| | 11 | | | | | |
| Exam- | Synthesis | 17 | 10 | A | 15 | A |
| ple 11 | Example | | | | | |
| | 12 | | | | | |
| Compar- | Compar- | 8 | 6 | B | 7 | B |
| ative | ative | | | | | |
| Exam- | Com- | | | | | |
| ple 1 | pound | | | | | |

As is clear from Table 1, in Examples 1-11 wherein a lower layer contains a specified phenol resin of the invention, a sharper image is obtained in comparison to Comparative Example 1. Further, Examples 1-11 were superior in scratch resistance, printing durability and chemical resistance and particularly superior in printing resistance of halftone dots, which are small area images.

### Example 12

A planographic printing plate precursor of Example 12 was produced by forming a recording layer (including a lower layer and an upper layer) on a support B prepared by forming an undercoat layer in the same manner as in the preparation of the support of Example 1 except that no silicate treatment was carried out after the anodic oxidation treatment.

The resulting photosensitive planographic printing plate was exposed in the same manner as in Example 1 and then was developed at a developing temperature of 28° C. for a developing time of 25 seconds using a PS processor 900HII manufactured by Fuji Film Co., Ltd. containing an alkali developer A having the following formulation. Thereafter, printing durability, chemical resistance, scratch resistance and image sharpness were evaluated in the same manner as for Example 1.

The results obtained were printing durability of 170,000 sheets, chemical resistance of 100,000 sheets and halftone dot printing durability of 150,000 sheets, which results are similar to the number of printed sheets obtained in Example 1. Further, the scratch resistance and the sharpness of images were also excellent as in Example 1.

It was thus understood that even in Example 12, in which a planographic printing plate using a support that had not been subjected to hydrophilization with silicate was developed with a silicate developer, excellent performance can be obtained similarly to Example 1, in which a planographic printing plate using a support that had been subjected to a silicate treatment was developed with a silicate-free developer.

<Composition of Alkaline Developer A>

| | |
|---|---|
| SiO₂.K₂O (K₂O/SiO₂ = 1/1(molar ratio)) | 4.0 parts by mass |
| citric acid | 0.5 parts by mass |
| polyethylene glycol-modified sorbitol | 1.0 part by mass |
| (adduct of 30 units on average) | |
| water | 50.0 parts by mass |

### Example 13

A planographic printing plate precursor was produced in the same manner as in Example 1 except that a support C, resulting from the preparation of a support described below, was used in place of the support used in Example 1. This planographic printing plate precursor was also subjected to evaluations the same as those conducted in Example 1, and a printing durability of 170,000 sheets, a chemical resistance of 100,000 sheets and a halftone dot printing durability of 150,000 sheets were obtained. The scratch resistance and the sharpness of images were also excellent as in Example 1.

(Preparation of Support C)

An aluminum plate (material: JIS A1050) 0.3 mm thick was subjected to an etching treatment using an aqueous solution having a caustic soda concentration of 30 g/l, an aluminum ion concentration of 10 g/l and a liquid temperature of 60° C. for 10 seconds. After washing with water, the resultant plate was neutralized with 10 g/l nitric acid, followed by washing with water. The aluminum plate was subjected to an electrochemical surface roughening treatment in an aqueous solution having a hydrogen chloride concentration of 15 g/l, an aluminum ion concentration of 10 g/l and a liquid temperature of 30° C., by applying an electric current having an alternating waveform of a sine wave under conditions of an applied voltage of 20 V with an electric charge of 500 C/dm². After subsequent washing with water, the aluminum plate was subjected to an etching treatment in an aqueous solution having a caustic soda concentration of 30 g/l, an aluminum ion concentration of 10 g/l and a liquid temperature of 40° C. for 10 seconds, followed by washing with water.

The aluminum plate was then subjected to desmutting treatment in a sulfuric acid aqueous solution having a sulfuric acid concentration of 15% by mass and a liquid temperature of 30° C., followed by washing with water.

Furthermore, it was subjected to an anodic oxidation treatment in a 10% by mass aqueous sulfuric acid solution at a liquid temperature of 20° C. under conditions of direct current with an electric current density of 6 A/dm² to provide an anodic oxidization film corresponding to 2.5 g/m², followed by washing with water and drying. Thereafter, it was treated with a 2.5% by mass aqueous sodium silicate solution at 30° C. for 10 seconds to yield a support. Measurement of the support for centerline average roughness (Ra) using a needle having a diameter of 2 μm revealed that it was 0.48 μm.

The thus-obtained silicate-treated aluminum support was coated with an undercoating liquid the same as that used in Example 1 and was dried at 80° C. for 15 seconds to yield support C having an undercoat layer in a coating amount after drying of 17 mg/m².

1. A planographic printing plate precursor comprising:
a support; and
a recording layer disposed on the support, the recording layer comprising a lower layer and an upper layer disposed on the lower layer,
wherein the lower layer contains a resin having in a main chain structure a phenol skeleton and a urea bond, the upper layer contains a water-insoluble alkali-soluble resin and an infrared absorber, and the solubility of the upper layer in an aqueous alkali solution is increased by exposure.

2. The planographic printing plate precursor of claim 1, wherein the resin having in the main chain structure a phenol skeleton and a urea has a structural unit represented by formula (I): 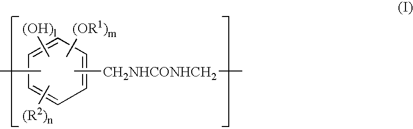
In formula (I), R¹ denotes an ether residue, an ester residue, an urethane residue or a carbonate residue, R² represents a monovalent organic residue having 1 to 20 carbon atoms, the organic residue may have a substituent. “l” denotes an integer of from 1 to 4, m and n each independently denote 0 or an integer of from 1 to 3, and “l”+m+n is in a range of 1 to 4.

3. The planographic printing plate precursor of claim 2, wherein R¹ and R² in formula (I) are groups defined below, and wherein R² may contain a substituent.

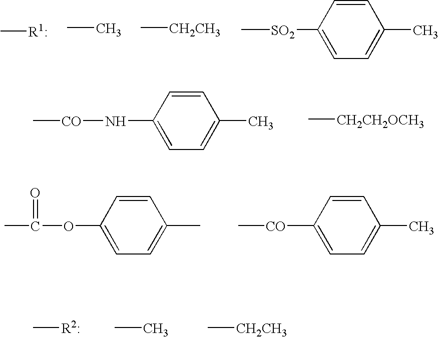

4. The planographic printing plate precursor of claim 2, wherein the resin having a phenol skeleton and a urea bond in the main chain contains the structural unit represented by formula (I) in an amount of 10 to 100% by mass in a molecule.

5. The planographic printing plate precursor of claim 1, wherein the resin having a phenol skeleton and a urea bond in the main chain is insoluble in water but soluble in an aqueous alkali solution.

6. The planographic printing plate precursor of claim 1, wherein the resin having a phenol skeleton and a urea bond in the main chain is a resin resulting from polycondensation of dimethylolurea and any monomer selected from a group consisting of phenols, bisphenols, hydroxynaphthalenes, and a low-molecular-weight condensed compound of p-cresol/formaldehyde.

7. The planographic printing plate precursor of claim 1, wherein the resin having a phenol skeleton and a urea bond in the main chain further contains a structural unit having an acid group.

8. The planographic printing plate precursor of claim 1, wherein the resin having a phenol skeleton and a urea bond in the main chain has a mass-average molecular weight of 1000 or more and a number-average molecular weight of 500 or more.

9. The planographic printing plate precursor of claim 8, wherein the resin having a phenol skeleton and a urea bond in the main chain has a mass-average molecular weight of 2000 to 50000 or more and a number-average molecular weight of 1000 to 20000.

10. The planographic printing plate precursor of claim 1, wherein the content of the resin having a phenol skeleton and a urea bond in the main chain in the lower layer is from 20 to 95% by mass based on the total solid content of the lower layer.

11. A planographic printing plate precursor comprising:
a support;
a lower layer disposed on the support, the lower layer containing a specified phenol resin having a structural unit represented by formula (1) below; and
an upper layer disposed on the lower layer, the upper layer containing a water-insoluble alkali-soluble resin and an infrared absorber, the solubility of the upper layer in an aqueous alkali solution being increased by exposure,
wherein the lower layer and the upper layer together form an image-recording layer. 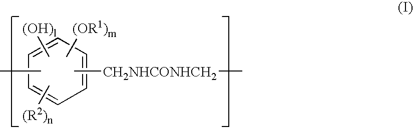
In formula (I), R¹ denotes an ether residue, an ester residue, an urethane residue or a carbonate residue, R² represents a monovalent organic residue having 1 to 20 carbon atoms, the organic residue may have a substituent. “l” denotes an integer of from 1 to 4, m and n each independently denote 0 or an integer of from 1 to 3, and “l”+m+n is in a range of 1 to 4.

12. The planographic printing plate precursor of claim 11, wherein the R¹ and R² in formula (I) are groups defined below, and wherein R² may contain a substituent.

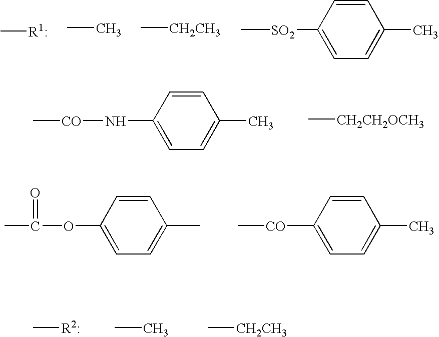

13. The planographic printing plate precursor of claim 11, wherein the specified phenol resin contains the structural unit represented by formula (I) in an amount of 10 to 100% by mass in a molecule.

14. The planographic printing plate precursor of claim 11, wherein the specified phenol resin is insoluble in water but soluble in an aqueous alkali solution.

15. The planographic printing plate precursor of claim 11, wherein the specified phenol resin is a resin resulting from polycondensation of dimethylolurea and any monomer selected from a group consisting of phenols, bisphenols, hydroxynaphthalenes, and a low-molecular-weight condensed compound of p-cresol/formaldehyde.

16. The planographic printing plate precursor of claim 11, wherein the specified phenol resin further contains a structural unit having an acid group.

17. The planographic printing plate precursor of claim 11, wherein the specified phenol resin has a mass-average molecular weight of 1000 or more and a number-average molecular weight of 500 or more.

18. The planographic printing plate precursor of claim 17, wherein the resin having a phenol skeleton and a urea bond in the main chain has a mass-average molecular weight of 2000 to 50000 or more and a number-average molecular weight of 1000 to 20000.

19. The planographic printing plate precursor of claim 11, wherein the content of the specified phenol resin in the lower layer is from 20 to 95% by mass based on the total solid content of the lower layer.
